(19) United States
(12) Patent Application Publication
(10) Pub. No.: US 2007/0232495 A1
(43) Pub. Date: Oct. 4, 2007

(54) Compositions and methods to add value to plant products, increasing the commercial quality, resistance to external factors and polyphenol content thereof

(76) Inventors: Alvaro Olivera Nappa, Santiago (CL); Felipe Camposano Lorenzini, Santiago (CL); Andres Leschot Sanhueza, Santiago (CL)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/728,267

(22) Filed: Mar. 23, 2007

(30) Foreign Application Priority Data
Mar. 24, 2006 (CL) 674-2006

(51) Int. Cl. A01N 57/00; A01N 43/00; A01N 37/34; A01N 37/10

(52) U.S. Cl. 504/194; 504/209; 504/309; 504/321

(57) ABSTRACT

The invention is related to compositions and methods that naturally protect plant tissues against ultraviolet radiation and temperature, thus giving protection against sunburn to plants, plant parts, fruits and/or flowers during their development. The invention is also related to compositions and methods to naturally improve the color of plants, plant parts, fruits and/or flowers by inducing the natural synthesis of flavonoids and anthocyanins present in plants. Likewise, the present invention is directed to improving the nutritional value of plants, plant parts, fruits and/or flowers by increasing the normal levels of polyphenolic compounds, especially flavonoids, present therein. Additionally, the present invention is related to compositions and methods that give more resistance to plants, plant parts, fruits and/or flowers against pathogens as bacteria and fungi. Finally, the present invention is related to plants, plant parts, fruits, flowers and/or propagating material treated with the compositions described in the present document.

### FIELD OF THE INVENTION

The invention is related to compositions and methods that protect against ultraviolet radiation, thus giving protection against sunburn to plants, plant parts, fruits and/or flowers during their development. The invention is also related to compositions and methods to naturally improve the color of plants, plant parts, fruits and/or flowers by inducing the natural synthesis of flavonoids and anthocyanins present in plants. Likewise, the present invention is directed to improving the nutritional value of plants, plant parts, fruits and/or flowers by increasing the normal levels of polyphenolic compounds, especially flavonoids, present therein. Additionally, the present invention is related to compositions and methods that give more resistance to plants, plant parts, fruits and/or flowers against pathogens as bacteria and fungi. Finally, the present invention is related to plants, plant parts, fruits, flowers and/or propagating material treated with the compositions described in the present document.

### BACKGROUND OF THE INVENTION

A suitable color development, which normally occurs simultaneously with ripening, is one of the most important parameters that affect the commercial value of fruits. In fact, a large percentage of produced fruit loses its commercial value due to the lack of quality standards caused by sunburn and/or lack of good color. Sunburn is generated while fruit is still on the tree and is exposed to particularly high amounts of solar radiation and high temperatures. Various degrees of sunburn can be distinguished on fruit, ranging from a slight discoloration of the natural fruit pigment to a severe burn that completely destroys (ulcerates) the plant tissue, in the worst case. When sunburn is present in produced fruit, either in a slight or maximum degree, the producer finds the sell price of its production dropping dramatically in all markets, being impossible to export said fruit due to consumer market norms and therefore the producer cannot participate of the market that yields the largest returns. Sunburn is not the only problem that affects fruit production, as crops are constantly at risk due to pathogens as fungi and bacteria. To fight this problem, producers need to use diverse agrochemical products in order to guarantee a good development of their future crops. Nevertheless, now the world market tendency is to be increasingly more cautious to accept the use of pesticides or fungicides on crops. Simultaneously, each year the world demand for healthy, pesticide-free and chemical-free food, as fruits and vegetables, is growing. Likewise, the interest for functional food, i.e., food having beneficial properties for human health, is also growing. Therefore, it would be very advantageous to have a product that naturally protects crops against these pathogens, simultaneously adding nutritional value to the food that consumers are increasingly eager to incorporate to their diet.

Part of human diet includes fruits and vegetables that in the whole contribute with vitamins, fiber, sugars, lipids, antioxidants and the like. One of the antioxidants produced by plants in large amounts to protect themselves against oxidative damage caused by UV radiation or other environmental aggressions is the group of molecules known as flavonoids. Anthocyanins are one subtype of flavonoids. They are molecules with red, blue or violet color that are present in plant tissues and are responsible for the characteristic colors of many ripe fruits. A flavonoid-rich diet helps removing free radicals from the body, retarding natural aging processes and fighting cancer development in the body, among many other health benefits. As many flavonoids are unstable molecules that do not resist cooking, it is recommended to consume them in the diet as fresh fruits and vegetables. Given the abovementioned facts, it would very interesting to have a way to improve the quality and amount of flavonoids available in plant food consumed by humans.

The present invention is directed to compositions and methods to decrease the harmful effects of solar radiation on plants, plant parts, flowers and fruits, also improving the color thereof and, additionally, increasing the nutritional value of plants by increasing the natural synthesis of antioxidants. This could imply a direct increase of the value and quality of fruit and the net income for the producers. The present invention proposes, definitely, the use of novel compositions for an original purpose.

Sunburn is caused by a combination of excessive heat and a high dose of UV radiation. In order to prevent or decrease sunburn or sun damage, plants, plant parts, fruits and/or flowers are sought to be protected against the harmful effects of heat and excessive UV radiation. If harmful UV effects are to be avoided, excess radiation can be reflected or screened by using clays or, in the other hand, said radiation excess can be absorbed by using chemical filters as waxes or some of the compounds of the present invention. Additionally, if the desired effect is a decrease in temperature, it can be achieved by shadowing the trees or by spraying water to cool the orchard by evaporation, as explained hereinafter. At present, some methods are known to protect plants (fruits) against sunburn, which are based in different indirect methodologies. Next, known commercial products of the present state of the art that offer protection against sunburn are mentioned:

“Raynox®”: Their manufacturers define it as a product that is applied over the tree (fruits), which is based on UV-absorbing plant waxes (carnauba wax). This wax deteriorates with solar radiation as time goes by, and due to this reason it is necessary to apply the product many times to achieve a notorious positive result.

“Surround®”: Their manufacturers define it as a reflecting product that is applied over the tree (fruits), where it screens UV and general solar radiation. This product is made from kaolin (mineral clay) as a suspension of finely divided white clay and it does not only reflect incident radiation on the fruits but also radiation that reaches the tree leaves. This obviously decreases the efficiency of the photosynthetic processes of the tree, which affects their own growth and the growth of its fruits, and also the general health of the tree. This clay suspension can also limit tree respiration because of stoma blockage. All this effects cause a higher general weakness of the plant and/or a decrease of fruit quality or amount, both in their color as in their size. In the other hand, it is possible that fruit growth causes the clay layer to break, thus losing a part of its protective ability, also requiring many applications during fruit growth and ripening.

“Sunshield®”: Their manufacturers define it as a product that is applied over the tree (fruits), where it filters UV radiation. This product is described as a biodegradable propolymer protein micro-layer. Sunshield's principle of action is similar to that of Raynox.

“Kool-Kore®” of: Their manufacturers define it as a product that is applied over the tree (fruits), based on silica and surfactants. This product has a principle of action similar to Surround's.

Another product is defined as secret mixtures of calcium carbonate, slime and clay. These mixtures are reflecting clays, and accordingly they operate using the same principle of action as Surround.

Another way to avoid harmful effects of solar radiation is by using protective meshes that filter solar light, thus shadowing the trees. Meshes are put over the trees in such a way that they shadow the fruits, by which it is possible to achieve a temperature reduction in the orchard, simultaneously reducing incident radiation over the trees. These meshes are expensive and the lower amount of light also affects negatively photosynthesis and fruit coloration processes.

Another technique used to reduce sunburn in fruit is water aspersion over the canopy of trees or between them during the hours of higher solar irradiation, in order to decrease the temperature of the fruit. Nevertheless, this option requires an expensive installation, constant water spraying removes agrochemical products previously applied over the trees and the increase in environmental humidity favors the development of plagues and weeds, affecting as a whole the phytosanitary status of the orchard.

As set forth hereinabove, sunburn is caused by a combination of excessive heat and a high dose of UV radiation. In order to prevent or decrease sunburn or sun damage, plants, plant parts, fruits and/or flowers are sought to be protected against the harmful effects of heat and excessive UV radiation. Therefore, as exposed when previous art was discussed, both products and methods to reflect or screen said radiation excess, or products that can absorb said radiation excess have been proposed.

It is well known that the ability of a compound to absorb UV radiation is directly related to its molecular structure. Thus, UV absorbing capacity is given by the presence of conjugated double bonds, e.g. in an aromatic structure. As the number of unsaturations in an aromatic molecule increases, the maximum wavelength said molecule can absorb decreases. UV radiation is invisible to the human eye and has a short wavelength comprised between 200 and 380 nm. The compositions disclosed in the present invention include compound derived from phenolic acids and preferably derived from the cinnamic acid skeleton. These compounds have a molecular structure that is able to absorb UV radiation by itself. Even when the ability of these molecules to absorb UV radiation is limited, these molecules play also an important protective role in living tissues as scavengers of free radical produced by diverse oxidative stress processes. Once one or more molecules derived from cinnamic acids has captured a harmful free radical, far from being inactivated, it can bond to one or more molecules of its own kind, i.e. another cinnamic acid derivative, to form new dimeric, trimeric or oligomeric structures. These new dimeric, trimeric or oligomeric structures have an even higher ability to absorb UV radiation and play even more important roles in the structure of plant cells, mainly as part of the hemicellulose and lignin structure of plant cell walls. The cinnamic acid derivatives that mainly play this structural and UV absorbing functions as part of lignin in plants are ferulic acid derivatives, caffeic acid derivatives and sinapic acid derivatives.

Additionally, obtaining fruit with a good coloration is as important for the producer as obtaining fruit with no sunburn damage. For some fruit, apples for example, color is the main feature that determines their market price, provided that there is no sunburn damage, surface bruises or other physiological disorders. Some of the techniques used at the present time to manage color in fruits include increasing the dose of potassium, magnesium or other oligoelements in fertilizers applied in the last stage of fruit development and/or stressing the tree by decreasing water supply, which affects the final color of the fruit, but limits its growth (size) and makes the treatment not always satisfactory.

In the past, Alar (daminozide) was used to increase color in fruit. Daminozide was used in some crops, mainly apples and ornamental plants, to improve the balance between vegetative growth and fruit production, improve fruit quality and synchronize fruit ripening. In 1989, a by-product of daminozide, called UDMH (unsymmetrical dimethylhydrazine), was found to be carcinogenic and therefore daminozide was classified as a moderate carcinogen and its use was forbidden for fruits or food products in many countries, allowing it to be sold only for use in ornamental plants.

At the present time, there is another phytostimulant alternative product (ethephon, 2-chloroethylphosphonic acid) that presents as a side effect the promotion of a better color in fruit, but this feature is associated to a higher ripening of said fruit. As aforementioned, fruit having better color reaches higher market values, but over-ripened fruit has a shorter conservation time before having to be discarded. Likewise, in Patent Application ES 2,137,893, a composition able to stimulate the development of color in skin and flesh of fruit and vegetables is disclosed. Said composition comprises 1 to 90% of a compound that contribute phosphite anion, 1 to 10% of methionine or a salt thereof, and 1 to 10% of glycine or a salt thereof. Nevertheless, the extra contribution of phosphite anion has some drawbacks such as the contribution of a disproportionate phosphorus amount to the plant in forms other than phosphate and possible environmental problems due to accumulation of non-assimilable and non-degradable phosphorus in soil.

As no available product is able to substantially improve color quality in fruits, there is also no marketed product able to improve color both in fruits and flowers. The possibility of having a product able to increase or improve flower coloration is therefore very interesting. A good color in flowers, such as roses or tulips, but not limited to those, is fundamental to achieve a good exporting market price. The present invention also offers an alternative able to improve color in flowers without stressing or genetically modifying the plant. For this, it is necessary to understand the mechanisms by which plants develop their colors. In plants there are 3 families of pigments that give rise to all colors found in the plant kingdom. Green, yellow and brown colors are given by chlorophyll-like molecules; the major part of yellow, orange and some red colors are produced by pigments known as carotenes; and blue, violet and most red colors are the result of a family of pigments known as anthocyanins.

The compositions of the present invention include phenolic acids and, more specifically, cinnamic acid derivatives, among which are p-coumaric acid, ferulic acid, caffeic acid and sinapic acid. Coumaric and ferulic acids constitute the major part of phenolic acids that are present in plant cell walls (Jung [1989], “Forage Lignins and their effect on fiber digestibility”. Agron J 81: 33-38). Phenolic acids exist in plant cell walls as monomers joined by ester and ether bonds, as sterified dimers and as crosslinked ester and ethers between polysaccharides and lignin (D. Deetz [1993], “Impact of Methyl-0-(E)-Feruloyl-α-L-Arabinofuranoside on In-vitro Degradation of Cellulose and xylan”. J Sci Food Agric 61:423-427), playing structural roles by strengthening the plant cell wall and making the plant more resistant to pathogen attack. As the crosslinking between phenolic acids belonging to different polysaccharide chains (normally hemicellulose) increases, the mechanical strength of the plant cell wall increases accordingly, as it becomes more tough and, being more crosslinked and structurally complex, it acquires more resistance against pathogen attack. Some phenolic acids and/or their derivatives are not digestible or even toxic for many soil or rumen microorganisms (C. Faulds [1991], “The purification and characterization of 4-hydroxy-3-methoxycinnamic (ferulic) acid esterase from Streptomyces olivochromogenes”. Journal of General Microbiology 137: 2339-2345), and therefore their antibiotic action is due both to the physical strength increase that they cause in the plant cell wall and to the toxic effect they have to certain bacteria. Amongst phenolic acid derivatives, cinnamates or cinnamic acid derivatives are mostly interesting, as they are precursors in hemicellulose chain lignification pathways during plant growth and ripening. It has been reported that cinnamic acid derivatives, particularly cinnamic acid esters, have antifungic properties (“Synthesis and antifungal activity of cinnamic acid esters”. Biosci Biotechnol Biochem, 1996, 60(5): 909-10). Cinnamates, particularly ferulic acid, can be used as food preservatives because of their ability to inhibit the oxidation of fatty acids and other molecules, aside from their function as antibiotics and/or antifungics, and they has been used as the active ingredient of some tanning lotions. Additionally, ferulic acid has been described to decrease the side effects of chemotherapy and radiotherapy, and further shows strong anti-inflammatory properties (C. Faulds [1997], “Novel biotransformation of agro-industrial cereal waste by ferulic acid esterases”. Industrial Crops and Products 6: 367-374).

As previously discussed, it is generally well known that UV radiation induces molecular level damage inside cells, mainly through two different and interdependent mechanisms. The first mechanism is direct damage caused to biomolecules through covalent bond breakage, which alters or destroys the biological function thereof. The second damage mechanism is produced through the interaction of UV radiation and electrons of organic molecules. This interaction breaks molecular bonds and generates free radicals, which auto-propagate in a chain reaction wherein each new step gives rise to new free radicals from intact molecules, thus causing a massive destruction of the organic molecules of the cell.

It is well known that in plants there is a large variety of secondary metabolites that play a protective role against external aggressions. These external aggressions may be caused by UV radiation, free radical generation, hydric stress, attack of pathogenic agents, herbivorous animals attack, etc. One of the more abundant groups of secondary metabolites a protective role in the cell is the group of flavonoids. Among them, aside from this general role in the entire plant kingdom, some sub-families of these compounds play specific non-protective roles (for example, pigments), and some flavonoid molecules have different functions inside each particular plant. In their chemical structure, biosynthetic pathways and functional role, flavonoids themselves are part of and are tightly related to other more general group of compounds, called in general phenolic compounds, also abundant in plants, either as primary metabolites (for example, tyrosines and phenylalanine) or secondary metabolites. The most relevant phenolic compounds in plants are shown in Table 1, along with their basic carbon skeleton (Harborne J. B., T. J. Marby, H. Marby: “The flavonoids”. London: Chapman and Hall, (1975)

TABLE 1
MOST RELEVANT PHENOLIC COMPOUND
CLASSES IN PLANTS

| Number of carbon | | |
|---|---|---|
| atoms | Basic skeleton | Class |
| 6 | C₆ | simple phenols, benzoquinones |
| 7 | C₆-C₁ | phenolic acids |
| 8 | C₆-C₂ | acetophenones, phenylacetic acids |
| 9 | C₆-C₃ | hydroxicinnamic acids, polypropenes, |
| | | coumarins, isocoumarins |
| 10 | C₆-C₄ | naphtoquinones |
| 13 | C₆-C₁-C₆ | xanthones |
| 14 | C₆-C₂-C₆ | stilbenes, anthraquinones |
| 15 | C₆-C₃-C₆ | flavonoids, isoflavonoids |
| 18 | (C₆-C₃)₂ | lignans, neolignans |
| 30 | (C₆-C₃-C₆)₂ | biflavonoids |
| n | (C₆-C₃)₂ | lignins, catecholmelanines |
| | (C₆ₙ | (condensed tannins) |
| | (C₆-C₃-C₆)ₙ | |

The starting product for the biosynthesis of most part of the phenolic compounds, including flavonoids, is shikimate. Phenols are acid owing to the dissociation of their —OH group. They are fairly reactive compounds and, as no steric hindrance due to side chains is present, they can form hydrogen bonds. In this way, many flavonoids have intramolecular bonds. Another relevant feature is their ability to form chelate complexes with metals. They are also easily oxidizable and when subjected to oxidation they generate polymers (dark aggregates). The browning of cuts or dead parts in plants is due to this reaction. Flavonoids have generally an inhibitory effect over plant growth. Among low molecular weight phenylpropanoid derivatives there is a variety of essences as coumarins, cinnamic acid, sinapinic (sinapic) acid, coniferyl alcohol and others. These substances and their derivatives are at the same time intermediates of lignin biosynthesis, where they are especially useful for their ability to polymerize and thus covalently crosslinking hemicellulose fibers.

Often, phenolic compounds, including flavonoids, are not free in plant tissues. In their major part, they are coupled to other molecules, most frequently with carbohydrate moieties (glycosylated), but they are also found coupled to sulfate or acetyl moieties. It is thought that one of the fundamental reasons for that is their toxicity in free state, as they are detoxified, at least in part, when coupled. Many low molecular weight compounds (e.g. thymol) are used in medicine as antiseptics because of their toxicity. The different types of bonds between a flavonoid molecule (for example, an anthocyanidin) and a glycosidic residue, lead to different derivatives that increase the color spectrum of flowers (and also their tonalities). Flavonoid glycosylation has an additional effect, a not less important function from an ecological point of view: it has been put into evidence their connection with protection against pests and other animals. Based on their biological functions, phenolic compounds can be classified as shown in Table 2 (Harborne, J. B., T. J. Marby, H. Marby: “The flavonoids”. London: Chapman and Hall, 1975).

TABLE 2
ECOLOGICAL SIGNIFICANCE OF SOME PHENOLIC
COMPOUNDS IN PLANTS

| | | Examples of plant species where the |
|---|---|---|
| Function | Group | effect has been studied |
| flower | anthocyans | Cyanidin-3,5-diglucoside in Rosa |
| pigments | chalcones | Coreopsin in Coreopsis tinctoria |
| | aurones | Aureusin in Anthirrhinum majus |
| | yellow flavonoids | Gossypetin-7-glucoside in Gossypium |
| | flavones | Apigenin-7-glucoside in Bellis |
| | | perennis |
| fruit | anthocyans | Petunidin glucoside in Atropa |
| pigments | | belladonna |
| | isoflavones | Osajin in Maclura pomifera |
| | chalcones | Okanin in Kyllinagi brevifolia |
| allelopathic | quinones | Juglone in Juglans regia |
| substances | phenols | Hydroquinone in Arctostaphylos |
| | phenolcarboxylic | Sialic acid in Quercus falcata |
| | acids | |
| | hydroxicinnamic | Ferulic acid in Adenostoma |
| | acids | |
| pest | quinones | Juglone in Carya ovata |
| protection | tannins | Gallotannin in Quercus robur |
| | flavonols | Quercetin glycosides in Gossypium |
| fungicides | isoflavones | Luteone in Lupinus |
| | phenolcarboxylic | Protocatechuic acid in Allium |
| | acids | |
| | dihydrochalcones | Phloridzin in Malus pumila |
| phytoalexins | stilbenes | Resveratrol in Arachis hypogaea |
| | phenylanthrenes | Orchinol in Orchis militaris |
| | isoflavans | Vestitiol in Lotus corniculatus |
| | pterocarpans | Pisatin in Pisum sativum |
| | phenyipropanoids | Coniferyl alcohol in Linum |
| | | utilissimum |
| | furocoumarins | Psoralen in Petroselinum crispum |

The basic structure of flavonoids is derived from the C₁₅ body of flavone. They differ from other phenolic substances in the oxidation degree of the central piran ring and, more fundamentally, also in their biological functions. While some flavonoid classes are colorless (flavanones, for instance), other classes' members (anthocyans, for example) are always colored and are known as pigments of flowers and other plant parts. Anthocyans are normally red or yellow, their color depending on pH. Blue pigments are obtained through the formation of chelates with some metallic ions (Fe³⁺ or Al³⁺, for instance).

Flavonoids in general are divided in subfamilies of compounds. The most important flavonoid molecule classes are shown in Table 3, altogether with their biological significance (Harborne, J. B., T. J. Marby, H. Marby: “The flavonoids”. London: Chapman and Hall, 1975).

TABLE 3
MOST IMPORTANT FLAVONOID CLASSES AND
THEIR BIOLOGICAL FUNCTION IN PLANTS

| | Number of | |
|---|---|---|
| | representative | Biological significance (as |
| Class | members | presently known) |
| Anthocyanin(s) | 250 | red and blue pigments |
| Chalcones | 60 | yellow pigments |
| Aurones | 20 | yellow pigments |
| Flavones | 350 | cream colored pigments of flowers |
| Flavonols | 350 | feed deterrents for herbivores in |
| | | leaves and UV filters |
| Dihydrochalcones | 10 | some of them taste bitter |
| Proanthocyanidins | 50 | astringent substances |
| Catechins | 40 | some of them have properties |
| | | similar to tannins |
| Biflavonoids | 65 | protective and pathogen defensive |
| | | function |
| Isoflavonoids | 15 | estrogenic effect, toxic for fungi |

The variability of flavonoids is based mainly in the hydroxilation and/or methylation pattern of the three ring system. A correlation between two flavonoids often points out to a relationship between the plant species that produce them. For this reason, they have proven to be suitable characters for the study of phylogenetic relationships between superior plants.

The flavonoid biosynthetic pathway is one of the most studied metabolic pathways in the plant kingdom, its study being started in 19^{th} century with the isolation of the first anthocyanins and flavonols. From then on, the pathway has been generally characterized for many plants. Nevertheless, even in our days this biosynthetic pathway has not been characterized in its entirety for any species, as each particular species produces different molecules depending on its own genetic information and its particular set of enzymes. A schematic representation of the general biosynthesis pathway of the most relevant and/or best characterized flavonoids as far as it is known in the present art, is presented in Scheme 1 (extracted from KEGG, Kyoto Encyclopedia of Genes and Genomes).

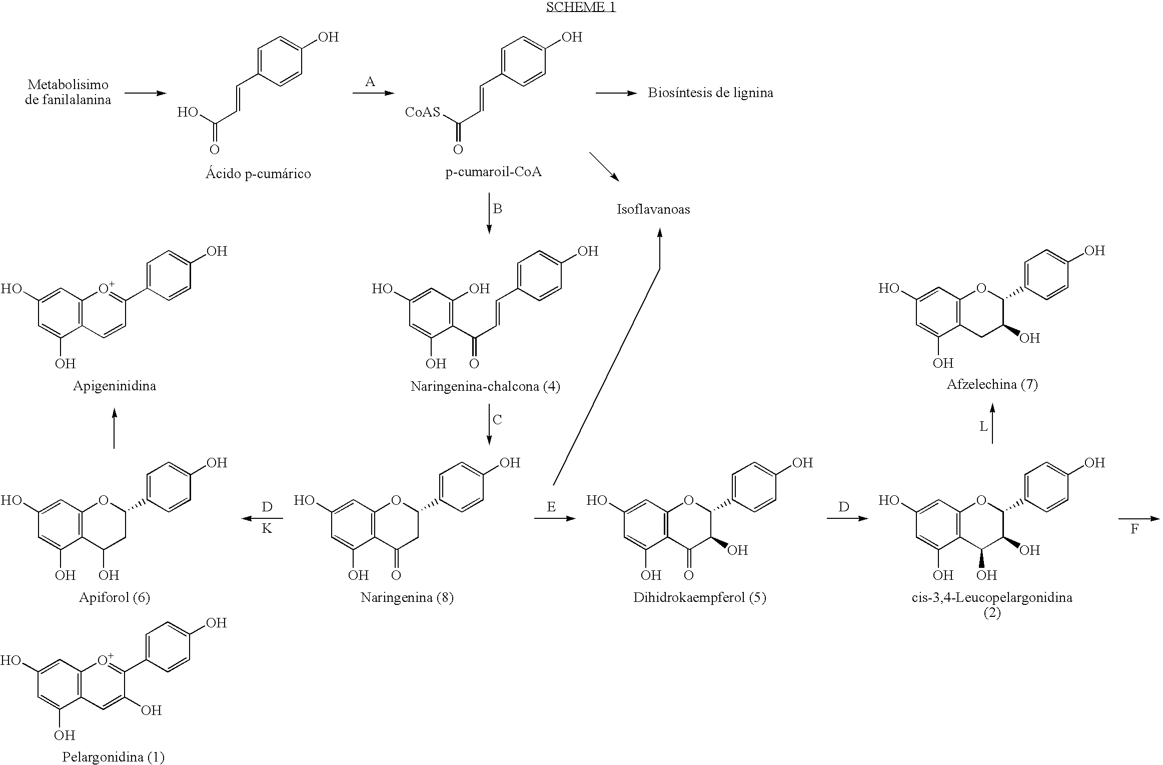

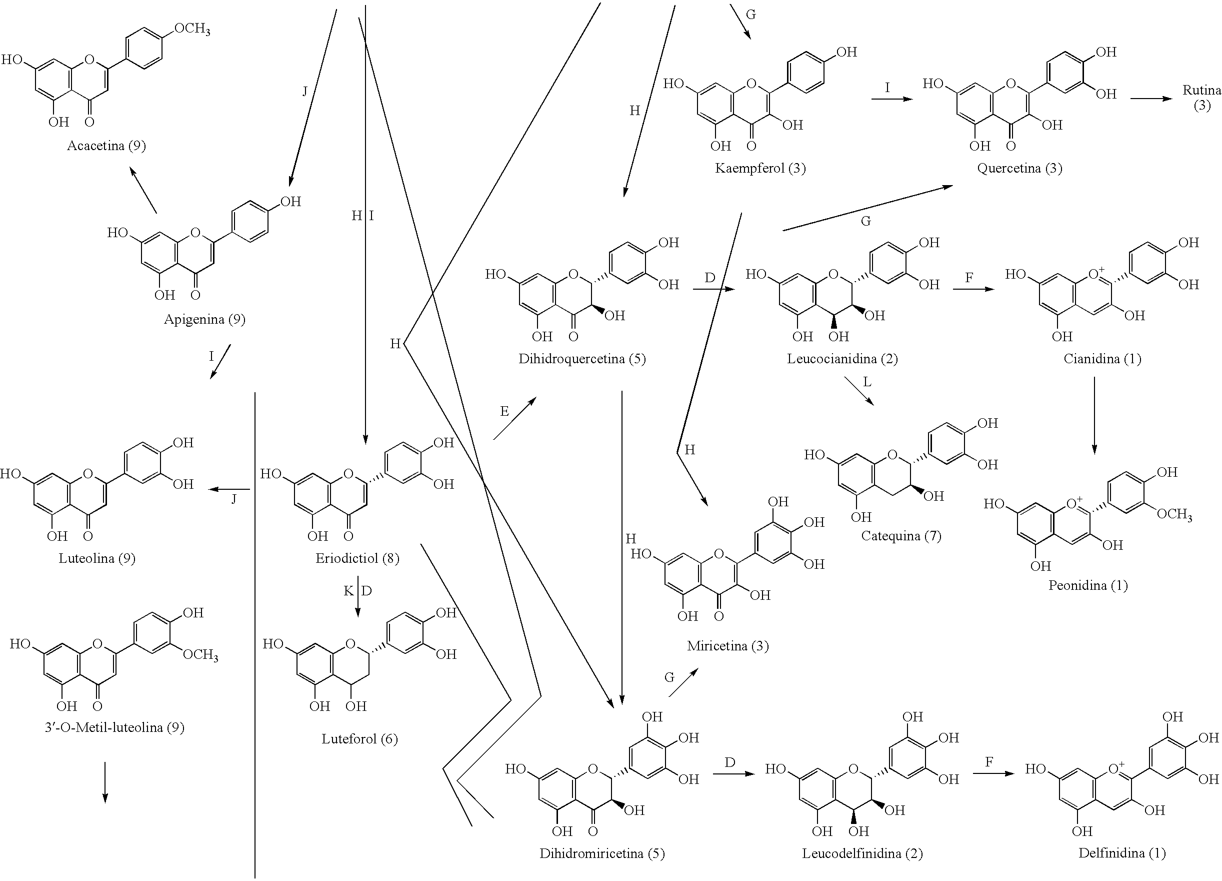

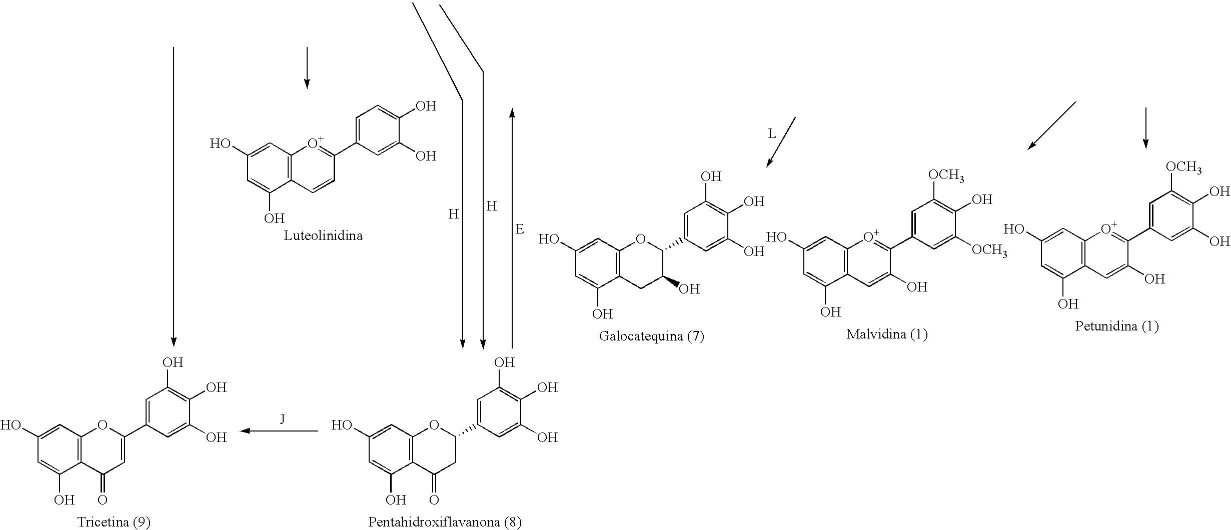

In Scheme 1, different representative classes of flavonoids are shown with the following number key, which is printed after the particular name of each molecule: (1) anthocyanidins, (2) leucoanthocyanidins, (3) flavonols, (4) chalcones, (5) dihydroflavonols, (6) flavan-4-ols, (7) flavan-3-ols (catechins), (8) flavanones, (9) flavones, and other compounds.

It is necessary to note that, according to the present knowledge, the entire flavonoid biosynthetic pathway naturally begins with p-coumaric acid and p-coumaroyl-CoA. This compound is directly derived from phenylalanine and tyrosine metabolism, and it is also the entrance point for the plant lignin biosynthesis pathway. In this biosynthetic pathway, p-coumarate is transformed also in other particular derivatives of cinnamic acid, especially cinnamic acid itself, ferulic acid, caffeic acid, 5-hydroxiferulic acid and sinapic acid, and their corresponding aldehydes and alcohols. Nevertheless, the present state of the art considers that these and other acid residues do not participate as major intermediates in flavonoid biosynthesis.

As it can be observed in Scheme 1, the abovementioned large variability of molecular structure of flavonoids in the plant kingdom is due to the action of a relatively small group of enzymes over the substrates available in the cell along the flavonoid biosynthetic pathway. Furthermore, it is evident that there is an interaction between groups of reactions, mediated by enzymes that simultaneously participate in two or more reactions. In Scheme 1, the 12 major known enzymes that participate in the flavonoid biosynthesis pathway are represented as follows:

A: EC 6.2.1.12, 4-coumarate-CoA ligase (4CL)

B: EC 2.3.1.74, chalcone synthase (CHS)

C: EC 5.5.1.6, chalcone isomerase (CHI)

D: EC 1.1.1.219, dihydroflavonol reductase (DFR)

E: EC 1.14.11.9, flavanone 3-dioxygenase (FHT)

F: EC 1.14.11.19, leucocyanidin oxygenase (ANS)

G: EC 1.14.11.23, flavonol synthase (FLS)

H: EC 1.14.13.88, flavonoid 3′,5′-hydroxilase

I: EC 1.14.13.21, flavonoid 3′-monooxygenase

J: EC 1.14.11.22, flavone synthase

K: EC 1.1.1.234, flavanone 4-reductase

L: EC 1.17.1.3, leucoanthocyanidin reductase

Furthermore, in Scheme 1 it is possible to observe the participation of many of these enzymes in different reactions, where substrates differ in the hydroxilation or methylation degree of the ring system. Bold arrows indicate reactions catalyzed by enzymes that accept substrates with different substituents in the phenyl ring, especially with no substituents (cinnamate derivatives) or 4-hydroxi substituted (coumarate derivatives), 4-hydroxi-3-methoxi substituted (ferulate derivatives), 3,4-dihydroxi substituted (caffeate derivatives), 4,5-dihydroxi-3-methoxi substituted (5-hydroxiferulate derivatives), 3,4,5-trihydroxi substituted (5-hydroxicaffeate derivatives) and 3,5-dimethoxi-4-hydroxi substituted (sinapate derivatives).

The specificity of each particular enzyme is given by its own molecular structure and this one depends in its turn on the species that produces it. In this way, each species “selects” its enzymes having varied specificities, which produce a particular and unique flavonoid set in a characteristic proportion between their components that is specific for each species.

Many experiments have been made by altering the expression of these enzymes in plants at the level of their genetic sequence. Specifically, gene knock-out tests and over-expression experiments has been made with some of these enzymes, normally observing a final effect in the concentration and proportion of the different flavonoid molecules produced by the plant tissue. Especially, many experiments have been made that report changes in the color of plant tissues, both in color tonality and shade, when the function of one of the enzymes of the metabolic pathway for anthocyanin biosynthesis is genetically altered. See as an example, the works of Saito and Yamazaki (2002), New Phytologist 155:9-23; Gollop, Even, ColovA-Tsolova and Perl (2002), Journal of Experimental Botany 53(373):1397-1409; Bruce, Folkerts, Garnaat, Crasta, Roth and Bowen (2000), Plant Cell 12:65-79; Winkel-Shirley (2001), Plant Physiology 126:485-493; Winkel-Shirley (2001), Plant Physiology 127:1399-1404; Muir, Collins, Robinson, Hughes, Bovy, De Vos, van Tunen and Verhoeyen (2001), Nature Biotechnology 19:470-474; DellaPenna (2001), Plant Physiology 125:160-163; Zhang, Franco, Curtin and Conn (2004), Journal of Biomedicine and Biotechnology 5:264-271; and Rosati, Cadic, Duron, Renou and Simoneau (1997), Plant Molecular Biology 35(3):303-311. Furthermore, part of the anthocyanin biosynthetic pathway has been cloned in Escherichia coli for the production of anthocyanins and flavonoids in microorganisms (Yan, Chemler, Huang, Martens and Koffas (2005), Applied Environmental Microbiology 71(7):3617-3623).

In this invention, we have surprisingly found that it is possible to modulate the flavonoid biosynthetic pathway by applying in situ phenolic compounds to living plant tissues, without genetically altering the expression of enzymes that participate in the corresponding pathways and without altering the genetic sequence of the producing plant. More surprisingly, it has been found that the external application to said tissues of some compounds that are not part of the flavonoid biosynthesis pathway, e.g. belonging to the lignin biosynthesis metabolic pathway, have a modulatory effect over metabolic routes that lead to flavonoid synthesis. In this way, phenolic compounds that can be used for the purposes of this invention can be part of the flavonoid biosynthesis pathway or not, and said phenolic compounds can even be molecules that are completely different to those molecules naturally found in the treated plant. Without losing generality, it is believed that these different compounds could be incorporated in the flavonoid biosynthesis reactions, as the enzymes that participate in said reactions could be able to accept substrates (or inhibitors) other than their natural substrates, with a variable degree of specificity. In this way, the plant would be able to generate flavonoids in larger amounts and in different ratios. It is believed that the plant could also synthesize flavonoid molecules that are not naturally present in the plant, by starting from the applied compounds.

Surprisingly, the compounds used in the formulations and applied according to the methods of the invention have demonstrated to be able to cross the waxy layer that protects the plant, especially over fruit skins, and have also demonstrated to be able to cross the cell membrane. Without losing generality, it is believed that, in this way, the applied compositions can modulate biosynthetic pathways inside the cells, especially the flavonoid biosynthesis pathway, and could participate in the reactions of said metabolic routes and modulate the function of the different enzymes that participate in said reactions.

### BRIEF DESCRIPTION OF THE INVENTION

The present invention is directed to compositions and protection methods against sun produced damage, improving and increasing color in plants and increasing the nutritional value of plants, plant parts, flowers and/or fruits through a change or increase of the content of polyphenolic compounds thereof, especially flavonoid content.

Said compositions have also antibiotic and antifungic properties associated to some of their components and induce antibiotic and antifungic properties that increase the resistance of treated plants against external pathogen and pest aggressions. These compositions are also able to increase the content of antioxidant compounds, especially polyphenols such as flavonoids, that can increase the nutritional value of the plants. The compositions of the present invention are similar to other agrochemical compositions and do not represent any risk during their handling if normal precautions for agrochemical products are minimally taken.

The present invention is also directed to protection methods against sunburn (to decrease its incidence) and to improve the color in plants, through the application of an effective amount of the compositions of the invention. Furthermore, the present invention is directed to methods to increase the content of polyphenolic compounds in plants, plant parts, flowers and/or fruits, through the application of an effective amount of the compositions of the invention.

Furthermore, the present invention is directed to the plants, plant parts, flowers and/or fruits treated with the compositions of the invention.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a graph showing the results for fruit color when using each of the three formulations described in the present disclosure;

FIG. 2 is a graph showing the results of all three Formulations A being assessed as protectants against sunburn damage intensity;

FIG. 3 shows the results of the tests performed with Formulations A to assess their effectiveness to decrease the total apple surface affected by sunburn damage;

FIG. 4 shows the results obtained for the categorization change of apples.

### DETAILED DESCRIPTION OF THE INVENTION

In this invention, we have found that it is possible to modulate the flavonoid biosynthetic pathway by applying in situ compositions that comprise phenolic compounds to living plant tissues, without genetically altering the expression of enzymes that participate in the corresponding pathways and without altering the genetic sequence of the producing plant. More surprisingly, it has been found that the external application to said tissues of some compounds that are not part of the flavonoid biosynthesis pathway, e.g. belonging to the lignin biosynthesis metabolic pathway, have a modulatory effect over metabolic routes that lead to flavonoid synthesis. In this way, phenolic compounds that can be used for the purposes of this invention can be part of the flavonoid biosynthesis pathway or not, and even said phenolic compounds can be molecules that are completely different to those molecules naturally found in the treated plant. Without losing generality, it is believed that these different compounds could be incorporated in the flavonoid biosynthesis reactions, as the enzymes that participate in said reactions could be able to accept substrates (or inhibitors) other than their natural substrates, with a variable degree of specificity. In this way, the plant would be able to generate flavonoids in larger amounts and in different ratios. It is believed that the plant could also synthesize flavonoid molecules that are not naturally present in the plant. by starting from the applied compounds.

Surprisingly, the compositions applied according to the methods of the invention have demonstrated to be able to cross the waxy layer that protects the plant, especially over fruit skins, and have also demonstrated to be able to cross the cell membrane. Without losing generality, it is believed that, in this way, the applied compositions can modulate biosynthetic pathways inside the cells, especially the flavonoid biosynthesis pathway, and could participate in the reactions of said metabolic routes and modulate the function of the different enzymes that participate in said reactions.

In this invention, it has been found that the effects of the application of these compositions and methods of the invention affect the ability of plant tissues to resist external aggressions. Specifically, it has been found that fruit treated with these compounds are more resistant to damage produced by sunburn, which is caused, at least in part, by incident UV radiation. Furthermore, the fruit treated with the compositions and methods of the invention develops better color when compared with untreated fruit. Finally, the absence of sunburn damage and the better natural color development affect the aesthetic appearance of the fruit and increase its commercial value in a very dramatic way.

At last, without being limited, both the resistance against UV radiation and the better color development could be explained through an increase in the amount of flavonoids and anthocyanins produced by the treatments of the invention, aside from the natural protective effect of the compounds of the invention. Without being limited by this, it is believed that the effect is principally due to an increase of the concentration of flavonols (especially quercetin in apples), dihydrochalcones (especially phloridzin and phloretin in apples) and anthocyanins (especially cyanidin and paeonidin in apples). Therefore, the compounds of the invention thus demonstrate their modulating ability over flavonoid biosynthesis in vivo.

An extra aspect of the treatments of the present invention is the increased amount of flavonoid molecules present in the plant tissues treated with the formulations and methods of the invention. This makes the treated plant, when included in human diet, a better source of flavonoids, which increases the nutritional value of the plant product, thus putting said product into the category of functional foods. Given the major contribution to human health represented by a daily intake of enough amounts of flavonoid compounds, plant products treated according to the invention would represent a substantial contribution in daily human diet, in comparison to an untreated plant product, thus improving the health state of the consumer. Furthermore, with this, the treatment of the invention allows increasing the commercial value of treated plant products and makes it possible to open new markets for the commercialization of said products.

Specifically, the compositions of the invention comprise at least one compound of Formula I: 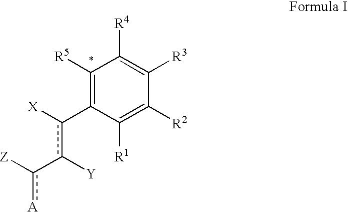
the salts, esters, ethers, solvates or isomers thereof, or their corresponding O- and/or N-glycosides; wherein R¹ to R⁴ are independently selected from the group consisting of hydrogen, halogen, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOH, —S(═O)ₙOR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, NO₂, —NO, —NH—NH₂, —NH—NHR⁶, —NH—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS, —SCN, an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶—S(═O)ₙOH, —S(═O)ₙOR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —NH—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS or —SCN;
R⁵ can be either the same as described for R¹ to R⁴ or it can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
R⁶ and R⁷ are independently selected from the group consisting of an alkyl, alkenyl, alkynyl, cycloalkyl, cycloalkenyl, cycloalkynyl, heterocycloalkyl, heterocycloalkenyl, heterocycloalkynyl, aryl, heteroaryl, organometallic, O-glycosyl or N-glycosyl group, which can be also substituted with one or more independently selected R⁹ groups;
R⁸ is ═O, ═S, ═NH, ═NR⁶, ═CH₂, ═CHR⁶, ═CR⁶R⁷;
R⁹ is selected from the group consisting of hydrogen, halogen, —OH, —OR¹⁰, —NH₂, —NHR¹⁰, —NR¹⁰R¹¹, —N—R¹², —C(═O)OH, —C(═O)OR¹⁰, —OS(═O)ₙOH, —OS(═O)ₙOR¹⁰, —S(═O)ₙOH, —S(═O)ₙOR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, PR¹⁰R¹¹, —PO₂, —PO, —P═R¹², —NO₂, —NO, —NH—NH₂, —NH—NHR¹⁰—NH—NR¹⁰R¹¹, —NHOH, —NR¹⁰OH, —NHOR¹⁰, —NR¹⁰OR¹¹, —N₂⁺, —N═NH, —N═NR¹⁰, —N═NOH, —N═NOR¹⁰, —N₃, —CN, —CNS, —SCN, an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R¹⁰, —OH, —OR¹⁰, —NH₂, —NHR¹⁰, —NR¹⁰R¹¹, —N—R¹², —C(═O)OH, —C(═O)OR¹⁰, —OS(═O)ₙOH, —OS(═O)ₙOR¹⁰, —S(═O)ₙOH, —S(═O)ₙOR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, PR¹⁰R¹¹, —PO₂, —PO, —P═R¹², —NO₂, —NO, —NH—NH₂, —NH—NHR¹⁰—NH—NR¹⁰R¹¹, —NHOH, —NR¹⁰OH, —NHOR¹⁰, —NR¹¹OR¹¹, —N₂⁺, —N═NH, —N═NR¹⁰, —N═NOH, —N═NOR¹⁰, —N₃, —CN, —CNS or —SCN;
R¹⁰ and R¹¹ are independently selected from the group consisting of an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, an organometallic group, an O-glycosyl group or an N-glycosyl group.
R¹² is ═O, ═S, ═NH, ═NR¹⁰, ═CH₂, ═CHR¹⁰, ═CR¹⁰R¹¹;
X, Y and Z are independently selected from the group consisting of hydrogen, an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, halogen, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O)ₙOR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —NH—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS, —SCN, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O)ₙOR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —NH—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS or —SCN; wherein X and Z could be bound forming a 5- to 7-membered ring, which could also be substituted with one or more independently selected R⁶ groups and/or could be part of a fused ring system, optionally substituted with one or more independently selected R⁹ groups; or R⁵ can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
A is hydrogen, ═O, ═S, ═NH, ═NR⁶, ═CH₂, ═CHR⁶, —CR⁶R⁷, halogen, —OH, —OR⁶, —NH₂, —NHR⁶, —NR⁶R⁷, N═R⁷, —C(═O)OH, —C(═O)OR⁶, —OS(═O)ₙOH, —OS(═O)ₙOR⁶, —S(═O)ₙOH, —S(═O)ₙOR⁶, —SH, —SR⁶, —C(═O)H, —C(═O)R⁶—OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —N—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS, —SCN, an organometallic group, an O-glycosyl group or a N-glycosyl group;
n is 0, 1 or 2;
a discontinuous line parallel to a continuous line represents an optional double bond;
with the proviso that all R¹ to R⁵ groups were simultaneously hydrogen, or at least one group R¹ to R⁵ must be —OH, —OCH₃, —NH₂, —NHR⁶, —NR⁶R⁷, O-glycosyl or N-glycosyl,
and at least one agrochemically acceptable vehicle.

More specifically, the compositions of the present invention include preferably at least one compound of Formula II: 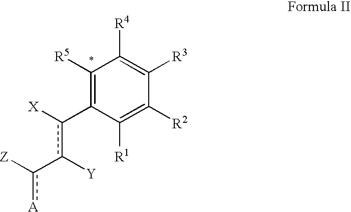
and the salts, esters, ethers, solvates or isomers thereof, or their corresponding O- and/or N-glycosides; wherein R¹ to R⁴ are independently selected from the group consisting of hydrogen, halogen, —OH, —OR⁶, —NH₂, —NHR⁶, —NR⁶R⁷, —N═R⁸, —C(═O)OH, —C(═O)OR⁶, —S(═O)₂OH, —S(═O)₂OR⁶, —SH, —SR⁶, —C(═O)H, —C(═O)R⁶—OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS, —SCN, a C₁-C₇ alkyl group, a C₂-C₇ alkenyl group, a C₂-C₇ alkynyl group, a C₃-C₁₁ cycloalkyl group, a C₄-C₁₁ cycloalkenyl group, a C₄-C₁₁ cycloalkynyl group, a 4- to 11-memebered heterocycloalkyl group, a 4- to 11-membered heterocycloalkenyl group, a 4- to 11-membered heterocycloalkynyl group, an aryl group, a heteroaryl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(═O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS or —SCN;
R⁵ can be either the same as described for R¹ to R⁴ or it can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
R⁶ and R⁷ are independently selected from the group consisting of a C₁-C₄ alkyl, C₂-C₄ alkenyl, C₂-C₄ alkynyl, C₃-C₆ cycloalkyl, C₄-C₆ cycloalkenyl, C₄-C₆ cycloalkynyl, 3- to 6-membered heterocycloalkyl, 4- to 6-membered heterocycloalkenyl, 4- to 6-membered heterocycloalkynyl, aryl, heteroaryl, organometallic, O-glycosyl or N-glycosyl group, which can be also substituted with one or more independently selected R⁹ groups;
R⁸ is ═O, ═S, ═NH, ═NR⁶, ═CH₂, ═CHR⁶, ═CR⁶R⁷;
R⁹ is selected from the group consisting of hydrogen, halogen, —OH, —OR¹⁰, —NH₂, —NHR¹⁰, NR¹⁰R¹¹, —N═R¹², —C(═O)OH, —C(═O)OR¹⁰, —S(═O)₂OH, —S(═O)₂OR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, —PR¹⁰R¹¹, —NO₂, —NO, —NH—NH₂, —NH—NHR¹⁰—NH—NR¹⁰R¹¹, NHOH, NR¹⁰OH —NHOR¹⁰—NR¹⁰R¹¹, —N═NH, —N═NR¹⁰, —N═NOH, —N═NOR¹⁰, —N₃, —CN, —CNS, —SCN, a C₁-C₄ alkyl group, a C₂-C₄ alkenyl group, a C₂-C₄ alkynyl group, a C₃-C₆ cycloalkyl group, a C₄-C₆ cycloalkenyl group, a C₄-C₆ cycloalkynyl group, a 3- to 6-membered heterocycloalkyl group, a 4- to 6-membered heterocycloalkenyl group, a 4- to 6-membered heterocycloalkynyl group, an aryl group, a heteroaryl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R¹⁰, —OH, —OR¹⁰, —NH₂, —NHR¹⁰, —NR¹⁰R¹¹, —N═R¹², —C(═O)OH, —C(═O)OR¹⁰, —S(═O)₂OH, —S(═O)₂OR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, —PR¹⁰R¹¹, —NO₂, —NO, —NH—NH₂, —NH—NHR¹⁰, —NH—NR¹⁰R¹¹, —NHOH, —NR¹⁰OH, —NHOR¹⁰, —NR¹⁰R¹¹, —N═NH, —N═NR¹⁰, —N═NOH, —N—NOR¹⁰, —N₃, —CN, —CNS or —SCN;
R¹⁰ and R¹¹ are independently selected from the group consisting of a C₁-C₄ alkyl, C₂-C₄ alkenyl, C₂-C₄ alkynyl, C₃-C₆ cycloalkyl, C₄-C₆ cycloalkenyl, C₄-C₆ cycloalkynyl, 3- to 6-membered heterocycloalkyl, 4- to 6-membered heterocycloalkenyl, 4- to 6-membered heterocycloalkynyl, aryl, heteroaryl, organometallic, O-glycosyl or N-glycosyl group;
X, Y and Z are independently selected from the group consisting of hydrogen, a C₁-C₇ alkyl group, a C₂-C₇ alkenyl group, a C₂-C₇ alkynyl group, a C₃-C₁₁ cycloalkyl group, a C₄-C₁₁ cycloalkenyl group, a C₄-C₁₁ cycloalkynyl group, a 3- to 11-membered heterocycloalkyl group, a 4- to 11-membered heterocycloalkenyl group, a 4- to 11-membered heterocycloalkynyl group, an aryl group, a heteroaryl group, halogen, —OH, —OR⁶, —NH₂, —NHR⁶, —NR⁶R⁷, —N═R⁸, —C(═O)OH, —C(═O)OR⁶, —S(═O)₂OH, —SO(═)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS, —SCN, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS or —SCN; wherein X and Z could be bound forming a 5 to 7-membered ring, which could also be substituted with one or more independently selected R⁹ groups and/or could be part of a fused ring system, optionally substituted with one or more independently selected R⁹ groups; or R⁵ can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
A is hydrogen, ═O, ═S, ═NH, ═NR⁶, ═CH₂, ═CHR⁶, —CR⁶R⁷, halogen, —OH, —OR⁶, —NH₂, —NHR⁶, —NR⁶R⁷, —N═R⁸, —C(═O)OH, —C(═O)OR⁹, —S(═O)₂OH, —S(═O)₂OR⁶, —SH, —SR⁶, —C(═O)H, —C(═O)R⁶, —OP(O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —N—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS, —SCN, an organometallic group, an O-glycosyl group or a N-glycosyl group;
a discontinuous line parallel to a continuous line represents an optional double bond;
with the proviso that all R¹ to R⁵ groups were simultaneously hydrogen, or at least one group R¹ to R⁵ must be —OH, —OCH₃, —NH₂, —NHR⁶, —NR⁶R⁷, O-glycosyl or N-glycosyl,
and at least one agrochemically acceptable vehicle.

Some phenolic compounds specifically preferred are compounds of Formula III: 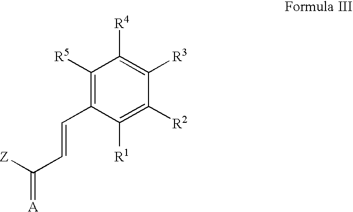
and the salts, esters, ethers, solvates or isomers thereof, or their corresponding O- and/or N-glycosides; wherein R¹ to R⁵ are independently selected from the group consisting of hydrogen, —OH, —OR⁶, —NH₂, —NHR⁶, —NR⁶R⁷, an O-glycosyl group or a N-glycosyl group;
R⁶ and R⁷ are independently selected from the group consisting of a C₁-C₃ alkyl, C₂ alkenyl, C₂ alkynyl, O-glycosyl or N-glycosyl group;
Z is selected from the group consisting of hydrogen, —OH, —OR⁶, —NH₂, —NHR⁶, —NR⁶R⁷, a phenyl group independently substituted with one or more groups —OH, —OR⁶, —NH₂, —NHR⁶, —NR⁶R⁷, an O-glycosyl group or a N-glycosyl group;
A is hydrogen, ═O, ═S, ═NH.

The phenolic compounds of Formula III especially preferred are: cinnamic acid, o-, m- and p-coumaric acids, caffeic acid, ferulic acid, sinapic acid, 5-hydroxicaffeic acid, 5-hydroxiferulic acid, 3,4,5-trimethoxicinnamic acid, o-, m- and p-coumaric alcohols, o-, m- and p-coumaric aldehydes, cinnamic alcohol, cinnamic aldehyde, caffeic alcohol, caffeic aldehyde, ferulic alcohol, ferulic aldehyde, coniferyl alcohol, sinapic aldehyde, 5-hydroxiferulic alcohol, 5-hydroxiferulic aldehyde, 5-hydroxicaffeic alcohol, 5-hydroxicaffeic aldehyde, 3,4,5-trimethoxicinnamic alcohol, 3,4,5-trimethoxicinnamic aldehyde, chalcone, naringenin-chalcone, eriodictyol-chalcone, pentahydroxiflavanone-chalcone, the glycosylated derivatives, dimers, trimers, and oligomers of the former compounds, and the like.

Other phenolic compounds specifically preferred are compounds of Formula IV: 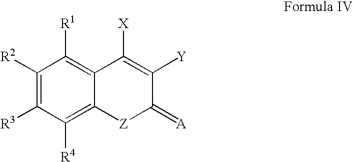
and the salts, esters, ethers, solvates or isomers thereof, or their corresponding O- and/or N-glycosides; wherein R¹ to R⁵ are independently selected from the group consisting of hydrogen, —OH, —OR⁶, —NH₂, —NHR⁶, —NR⁶R⁷, an O-glycosyl group or a N-glycosyl group;
R⁶ and R⁷ are independently selected from the group consisting of a C₁-C₃ alkyl, C₂ alkenyl, C₂ alkynyl, O-glycosyl or N-glycosyl group;
X and Y are independently selected from the group consisting of hydrogen, —OH, —OR⁶, —NH₂, —NHR⁶, —NR⁶R⁷, an O-glycosyl group or an N-glycosyl group;
Z is selected from —CH₂—, —CHR⁶—, —CR⁶R⁷—, —O—, —NH—, —NR⁶—, —S—;
A is hydrogen, ═O, ═S, ═NH.

The phenolic compounds of Formula IV especially preferred are: coumarin, umbelliferone, 6,7-dihydroxicoumarin, 7,8-dihydroxicoumarin, 4,5,7-trihydroxicoumarin, 7-methoxicoumarin (O-methylumbelliferone), 6,7-dimethoxicoumarin, the glycosylated derivatives, dimers, trimers, and oligomers thereof, and the like.

Other phenolic compounds specifically preferred are compounds of Formula V: 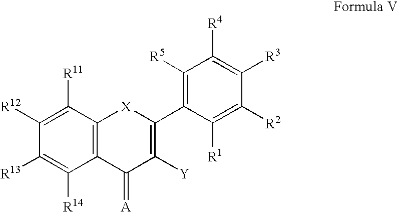
the salts, esters, ethers, solvates or isomers thereof, or their corresponding O- and/or N-glycosides; wherein R¹ to R⁵ are independently selected from the group consisting of hydrogen, —OH, —OR⁶, —NH₂, —NHR⁶, —NR⁶R⁷, an O-glycosyl group or a N-glycosyl group;
R⁶ and R⁷ are independently selected from the group consisting of a C₁-C₃ alkyl, C₂ alkenyl, C₂ alkynyl, O-glycosyl or N-glycosyl group;
R¹¹ to R¹⁴ are independently selected from the group consisting of hydrogen, —OH, —OR⁶, —NH₂, —NHR⁶, —NR⁶R⁷, an O-glycosyl group or an N-glycosyl group;
X is selected from —CH₂—, —CHR⁶—, —CR⁶R⁷—, —O—, —NH—, —NR⁶—, —S—;
Y is selected from the group consisting of hydrogen, —OH, —OR⁶, —NH₂, —NHR⁶, —NR⁶R⁷, an O-glycosyl group or an N-glycosyl group;
A is hydrogen, ═O, ═S, ═NH.

The phenolic compounds of Formula V especially preferred are: naringenin, afzelechin, apigeninidin, apiforol, dihydrokaempferol, leucopelargonidin, kaempferol, quercetin, acacetin, apigenin, dihydroquercetin, leucocyanidin, catechin, miricetin, luteolin, eriodictyol, leucopaeonidin, 3′-O-methyl-luteolin, luteoforol, luteolinidin, gallocatechin, leucodelphinidin, leucopetunidin, leucomalvidin, tricetin, pentahydroxiflavanone, the glycosylated derivatives, dimers, trimers, and oligomers thereof, and the like.

The term “alkyl”, unless specified otherwise, when used herein, alone or as part of another group, preferably includes straight or branched chain hydrocarbons containing 1 to 20 carbons, preferably 1 to 10 carbons, more preferably 1 to 8 carbons in the normal chain, such as methyl, ethyl, propyl, isopropyl, butyl, t-butyl, isobutyl, pentyl, hexyl, isohexyl, heptyl, 4,4-dimethylpentyl, octyl, 2,2,4-trimethyl-pentyl, nonyl, decyl, undecyl, dodecyl, the diverse branched chain isomers thereof, and the like, and also said groups including 1 to 4 substituents such as halogen, e.g. F, Br, Cl or I, or —CF₃, alkyl, alkoxi, aryl, aryloxi, aryl(aryl) or diaryl, arylalkyl, arylalkyloxi, alkenyl, cycloalkyl, cycloalkylalkyl, cycloalkylalkyloxi, amino, hydroxi, hydroxialkyl, acyl, heteroaryl, heteroaryloxi, heteroarylalkyl, heteroarylalkoxi, aryloxialkyl, alkylthio, arylalkylthio, aryloxiaryl, alkylamido, alkanoylamino, arylcarbonylamino, nitro, ciano, thiol, haloalkyl, trihaloalkyl and/or alkylthio.

The term “cycloalkyl”, unless specified otherwise, when used herein, alone or as part of another group, includes cyclic saturated or partially unsaturated hydrocarbon groups having 1 to 3 rings, including monocyclic alkyl, bicyclic alkyl (or bicycloalkyl) and tricyclic alkyl(tricycloalkyl), containing a total of 3 to 20 carbon ring atoms, preferably 3 to 10 carbon ring atoms, and that may be fused to 1 or 2 aromatic rings, such as those described for aryl, including cyclopropyl, cyclobutyl, cyclopentyl, cyclohexyl, cycloheptyl, cyclooctyl, cyclodecyl and cyclododecyl, cyclohexenyl, adamantyl, bornyl, and the like.

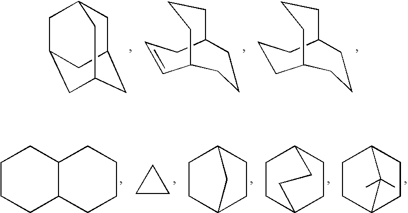

Any of these groups may be optionally substituted with 1 to 4 substituents such as halogen, alkyl, alkoxi, hydroxi, aryl, aryloxi, arylalkyl, cycloalkyl, hydroxialkyl, alkylamido, alcanoylamino, oxo, acyl, arylcarbonylamino, amino, nitro, ciano, thiol and/or alkylthio, and/or any of the substituents specified for “alkyl”.

The term “cycloalkenyl” as used herein, alone or as part of another group, refers to cyclic partially unsaturated hydrocarbons having 3 to 12 carbon atoms, preferably 5 to 10 carbon atoms, and 1 or 2 double bonds per ring. Exemplary cycloalkenyl groups include cyclopentenyl, cyclohexenyl, cycloheptenyl, cyclooctenyl, cyclohexadienyl, and cycloheptadienyl, which may be optionally substituted as specified for cycloalkyl.

The term “cycloalkynyl” as used herein, alone or as part of another group, refers to cyclic partially unsaturated hydrocarbons having 3 to 12 carbon atoms, preferably 5 to 10 carbon atoms, and 1 or 2 triple bonds. Exemplary cycloalkynyl groups include cyclopentynyl, cyclohexynyl, cycloheptynyl, cyclooctynyl, which may be optionally substituted as specified for cycloalkyl.

The term “alkenyl”, unless specified otherwise, as used herein, alone or as part of other group, refers to straight or branched chain hydrocarbons having 2 to 20 carbon atoms, preferably 2 to 12 carbon atoms, and more preferably 1 to 8 carbon atoms in the normal chain, and having one to six double bonds in the normal chain, such as vinyl, 2-propenyl, 3-butenyl, 2-butenyl, 4-pentenyl, 3-pentenyl, 2-hexenyl, 3-hexenyl, 2-heptenyl, 3-heptenyl, 4-heptenyl, 3-octenyl, 3-nonenyl, 4-decenyl, 3-undecenyl, 4-dodecenyl, 4,8,12-tetradecatrienyl, and the like, which may be optionally substituted with 1 to 4 substituents, mainly halogen, haloalkyl, alkyl, alkoxi, alkenyl, alkynyl, aryl, arylalkyl, cycloalkyl, amino, hydroxi, heteroaryl, cycloheteroalkyl, alkanoylamino, alkylamido, arylcarbonyl-amino, nitro, ciano, thiol, alkylthio and/or any of the alkyl substituents herein described.

The term “alkynyl”, unless specified otherwise, as used herein, alone or as part of other group, refers to straight or branched chain hydrocarbons having 2 to 20 carbon atoms, preferably 2 to 12 carbon atoms, and more preferably 2 to 8 carbon atoms in the normal chain, and having a triple bond in the normal chain, such as 2-propinyl, 3-butinyl, 2-butinyl, 4-pentinyl, 3-pentinyl, 2-hexinyl, 3-hexinyl, 2-heptinyl, 3-heptinyl, 4-heptinyl, 3-octinyl, 3-noninyl, 4-decinyl, 3-undecinyl, 4-dodecinyl, and the like, which may be optionally substituted with 1 to 4 substituents, mainly halogen, haloalkyl, alkyl, alkoxi, alkenyl, alkynyl, aryl, arylalkyl, cycloalkyl, amino, hydroxi, heteroaryl, cycloheteroalkyl, alkanoylamino, alkylamido, arylcarbonyl-amino, nitro, ciano, thiol, alkylthio and/or any of the alkyl substituents herein described.

The term “halogen” as used herein, alone or as part of other group, refers to chloro, bromo, fluoro, and iodo, and also —CF₃, preferably chloro and fluoro.

The term “aryl”, unless specified otherwise, alone or as part of other group, refers to monocyclic or bicyclic aromatic groups having 6 to 10 carbon ring atoms (such as phenyl or naphtyl, including 1-naphtyl and 2-naphtyl) and they can optionally include one to three additional rings fused to a carbocyclic or a heterocyclic ring (such as aryl, cycloalkyl, heteroaryl or cycloheteroalkyl rings), for example: 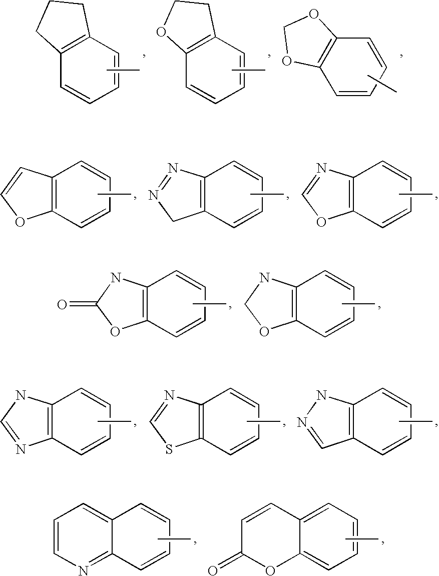
and that may optionally be substituted at available carbon atoms with 1, 2 or 3 groups selected from hydrogen, halogen, haloalkyl, alkyl, haloalkyl, alkoxi, haloalkoxi, alkenyl, trifluoromethyl, trifluoromethoxi, alkynyl, cycloalkylalkyl, cycloheteroalkyl, cycloheteroalkylalkyl, aryl, heteroaryl, arylalkyl, aryloxi, aryloxialkyl, arylalkoxi, arylthio, arylazo, heteroarylalkyl, heteroarylalkenyl, heteroarylheteroaryl, heteroaryloxi, hydroxi, nitro, ciano, amino, substituted amino wherein the amino include 1 or 2 substituents (which are alkyl, aryl or any of the other hydrocarbon compounds mentioned in the definitions), thiol, alkylthio, arylthio, heteroarylthio, arylthioalkyl, alkoxiarylthio, alkylcarbonyl, arylcarbonyl, alkylaminocarbonyl, arylaminocarbonyl, alkoxicarbonyl, aminocarbonyl, alkylcarbonyloxi, arylcarbonyloxi, alkylcarbonylamino, arylcarbonylamino, arylsulfinyl, arylsulfinylalkyl, arylsulfonylamino or arylsulfonaminocarbonyl and/or any of the alkyl substituents herein mentioned.

The term “heterocycloalkyl”, unless specified otherwise, as used herein, alone or as part of other group, refers to a cycloalkyl having at least one of the carbon atoms of the ring replaced by an atom other than carbon, such as nitrogen, oxygen or sulfur, such as e.g., morpholinyl, imidazolidinyl, pyrrolidinyl, pyrazolidinyl, piperidyl, piperazinyl, isochromanyl, chromanyl, indolinyl, isoindolinyl, quinuclidinyl, and the like.

The term “heterocycloalkenyl”, unless specified otherwise, as used herein, alone or as part of other group, refers to a cycloalkenyl having at least one of the carbon atoms of the ring replaced by an atom other than carbon, such as nitrogen, oxygen or sulfur, such as e.g., imidazolinyl, pyrrolinyl, pyrazolinyl, and the like.

The term “heterocycloalkynyl”, unless specified otherwise, as used herein, alone or as part of other group, refers to a cycloalkynyl having at least one of the carbon atoms of the ring replaced by an atom other than carbon, such as nitrogen, oxygen or sulfur.

The term “heteroaryl”, unless specified otherwise, as used herein, alone or as part of other group, refers to a monocyclic or bicyclic aromatic nucleus having 5 to 10 elements, which includes 1, 2, 3 or 4 heteroatoms such as nitrogen, oxygen or sulfur, including possible N-oxides. The heteroaryl group may optionally include 1 to 4 substituents such as any of the substituents herein described for alkyl. The examples of heteroaryl groups include the following: 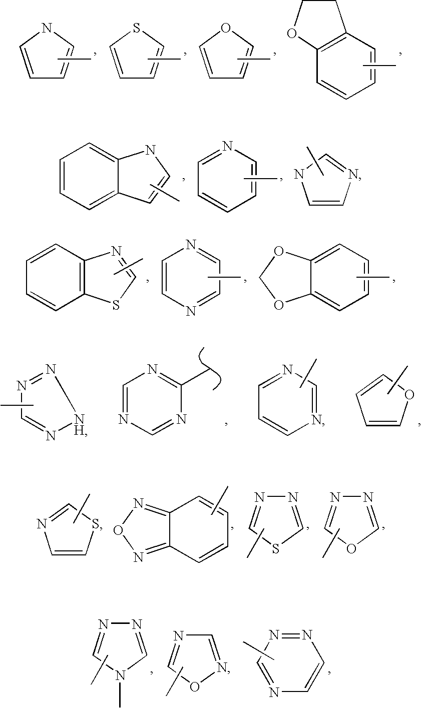
thiazolyl, isothiazolyl, indolyl, isoindolyl, indazolyl, purinyl, quinolyl, isoquinolyl, ftalazinyl, naftiridinyl, quinoxalinyl, quinazolinyl, cinnolinyl, pteridinyl, carbazolyl, carbolinyl, phenantridinyl, acridinyl, perimidinyl, phenantrolinyl, phenazinyl, phenothiazinyl, isoxazolyl, oxazolyl, furazanyl, phenoxazinyl, imidazolyl, pyranyl, pyrazolyl, benzothienylthianthrenyl, benzofuranyl, isobenzofuranyl, piridazinyl, indolizinyl and the like.

The compositions of the invention comprise compounds of Formula I in any common suitable agrochemical composition that allows dissolution, emulsion or suspension thereof. In this type of composition, compounds of Formula I can be found as a single compound, in mixtures of different compounds of Formula I, or in mixtures comprising at least one compound of Formula I and any other agrochemical product, and at least one agrochemically acceptable vehicle.

Said other agrochemical product may be, for example, a pesticide, a fungicide or an herbicide. For example, the pesticide may be a pyrethroid-based pesticide such as allethrin, tetramethrin, resmethrin, phenothrin, furamethrin, permethrin, cypermethrin, deltamethrin, cyhalothrin, cyfluthrin, fenpropathrin, tralomethrin, cycloprothrin, flucythrinate, fluvalinate, acrinathrin, tefluthrin, bifenthrin, empenthrin, betA-cyfluthrin, fenvalerate, esfenvalerate, flubrocythrinate, metofluthrin, profluthrin, dimefluthrin, silafluofen, pyrethrum extract, etofenprox, halfenprox and the like; an organophosphate-based pesticide such as DDVP, cyanophos, fenthion, fenitrothion, tetrachlorvinphos, dimethylvinphos, propaphos, methyl parathion, temephos, phoxim, acephate, isofenphos, salithion, DEP, EPN, ethion, mecarbam, pyridafenthion, diazinon, pirimiphos-methyl, etrimfos, isoxathion, quinalphos, chlorpyrifos-methyl, chlorpyrifos, phosalone, phosmet, methidathion, oxydeprofos, vamidothion, malathion, phenthoate, dimethoate, formothion, thiometon, ethylthiometon, phorate, terbufos, profenofos, prothiofos, sulprofos, pyraclofos, monocrotophos, naled, fosthiazate, trichlorfon, ethoprophos, cadusafos, chlorfenvinphos, dichlofenthion, ethylthiometon, methamidophos, dichlorvos, tebupirimfos, omethoate, triazophos, oxydemeton-methyl, azinphos-methyl, chlorethoxyphos, dicrotophos, disulfoton, fenamiphos, phosphamidon, chlormephos, demeton-5-methyl, mevinphos, parathion and the like; a carbamate-based pesticide such as NAC, MTMC, MIPC, BPMC, XMC, PHC, MPMC, ethiofencarb, bendiocarb, pirimicarb, carbosulfan, benfuracarb, methomyl, oxamyl, aldicarb, thiodicarb, alanycarb, carbofuran, methiocarb, fenothiocarb, formetanate, xylylmethylcarbamate, propoxur, isoprocarb and the like; a neonicotinoid-based pesticide such as imidacloprid, nitenpyram, acetamiprid, dinotefuran, thiamethoxam, thiacloprid, clothianidin and the like; an organochlorine-based pesticide such as bromopropylate, dicofol, endosulfan, lindane and the like; an insect growth regulator such as diflubenzuron, chlorfluazuron, teflubenzuron, triflumuron, flufenoxuron, flucycloxuron, hexaflumuron, fluazuron, diafenthiuron, novaluron, noviflumuron, bistrifluoron, chromafenozide, halofenozide, methoxyfenozide, lufenuron, cyromazine, triazamate and the like; a natural product-based pesticide such as nicotine sulphate, polynactin complex, abamectin, milbemectin, lepimectin, BT (Bacillus thuringiensis) agent, spinosad, rotenone and the like; cartap, thiocyclam, bensultap, pymetrozine, fipronil, buprofezin, fenoxycarb, pyriproxyfen, methoprene, hydroprene, kinoprene, endosulfan, triazuron, tebufenozide, benzoepin, emamectin, emamectin benzoate, flupyrazophos, fluacrypyrim, flufenzin, indoxacarb, tolfenpyrad, gammA-cyhalothrin, ethiprole, acetoprole, amidoflumet, chlorfenapyr, flonicamid, flufenerim, pyridalyl, sodium oleate, potassium oleate, azadirachtin, carbam, sodium carbam, propargite, azocyclotin, benzoximate, metaldehyde, protrifenbute, benclothiaz, flubendiamide, metaflumizole; an acaricide such as chlorobenzilate, fenisobromolate, tetradifon, CPCBS (chlorfenson), BPPS, chinomethionat, amitraz, benzomate, hexythiazox, fenbutatin oxide, cyhexatin, dienochlor, clofentezine, pyridaben, fenpyroximate, fenazaquin, tebufenpyrad, pyrimidifen, acequinocyl, bifenazate, etoxazol, spirodiclofen, spiromesifen, amidoflumet and diflovidazin, and other pesticides with similar action used in agricultural, horticultural, fruticultural or floricultural applications.

For example, the fungicide may be an azole-based fungicide such as triadimefon, hexaconazole, propiconazole, ipconazole, prochloraz, triflumizole, tebuconazole, epoxiconazole, difenoconazole, flusilazole, triadimenol, cyproconazole, metconazole, fluquinconazole, bitertanol, tetraconazole, triticonazole, flutriafol, penconazole, diniconazole, fenbuconazole, bromuconazole, imibenconazole, simeconazole, myclobutanil, hymexazole, imazalil, furametpyr, thifluzamide, etridiazole, oxpoconazole, oxpoconazole fumarate, pefurazoate, prothioconazole and the like; a pyrimidine-based fungicide such as pyrifenox, fenarimol, nuarimol, bupirimate and the like; an anilinopyrimidine-based fungicide such as mepanipyrim, cyprodinil, pyrimethanil, diflumetorim and the like; an acylalanine-based fungicide such as metalaxyl, metalaxyl-M, oxadixyl, benalaxyl and the like; a benzimidazole-based fungicide such as thiophanate-methyl, benomyl, carbendazim, fuberidazole, thiabendazole and the like; an organosulfur fungicide such as mancozeb, propineb, zineb, metiram, maneb, ziram, thiuram, amobam, polycarbamate, thiadiazine and the like; an organochlorine fungicide such as tetrachloroisophthalonitrile and the like; a carboxam-based fungicide such as ethaboxam, oxycarboxin, carboxin, flutolanil, silthiofam, mepronil, boscalid and the like; a morpholine-based fungicide such as dimethomorph, fenpropidin, fenpropimorph, spiroxamine, tridemorph, dodemorph, flumorph and the like; a strobilurin-based fungicide such as azoxystrobin, kresoxim-methyl, metominostrobin, oryzastrobin, fluoxastrobin, trifloxystrobin, dimoxystrobin, pyraclostrobin, picoxystrobin and the like; a dicarboximide-based fungicide such as iprodione, procymidone, vinclozolin, chlozolinate and the like; a soil fungicide such as flusulfamide, dazomet, methyl isothiocyanate, chloropicrin, methasulfocarb, hydroxyisoxazole, potassium hydroxyisoxazole, echlomezol, dichloropropene, carbam, methyl iodide and the like; a copper-based fungicide such as basic copper chloride, basic copper sulfate, copper nonylphenolsulfonate, oxine copper, DBEDC, anhydrous copper sulfate, copper sulfate pentahydrate, copper hydroxide and the like; an inorganic fungicide such as inorganic sulfur, wettable sulfur powder, lime sulfur, zinc sulfate, fentin, sodium hydrogen carbonate, potassium hydrogen carbonate, hypochlorite salts, metallic silver and the like; an organophosphate-based fungicide such as edifenphos, tolclofos-methyl, fosetyl, iprobenfos, dinocap, pyrazophos and the like; a melanin biosynthesis inhibitor-based fungicide such as carpropamid, fthalide, tricyclazole, pyroquilon, diclocymet, fenoxanil and the like; an antibiotic fungicide such as kasugamycin, validamycin, polyoxin derivative, blasticidin S, tecloftalam, oxytetracycline, mildiomycin, streptomycin and the like; a natural product-based fungicide such as rape seed oil, machine oil and the like; a carbamate-based fungicide such as benthiavalicarB-isopropyl, iprovalicarb, propamocarb, diethofencarb and the like; a pyrrole-based fungicide such as fluoroimide, fludioxonil, fenpiclonil and the like; a plant activator for leading resistance to plant diseases such as probenazole, acibenzolar-5-methyl, tiadinil and the like; a quinoline-based fungicide such as quinoxyfen, oxolinic acid and the like; cyflufenamid, fenhexamid, metrafenone, picobenzamid, proquinazid, famoxadone, cyazofamid, fenamidone, zoxamide, chlorothalonil, cymoxanil, captan, dithianon, fluazinam, folpet, dichlofluanid, triforine, isoprothiolane, ferimzone, diclomezine, pencycuron, chinomethionat, iminoctadine acetate, iminoctadine albesilate, guazatine, chloroneb, organonickel, dodine, quintozene, tolylfluanid, anilazine, nitrothal-isopropyl, fenitropan, dicloran, DPC, dimethirimol, benthiazole, flumetover, mandipropamid and other fungicides with similar action used in agricultural, horticultural, fruticultural or floricultural applications.

Additionally, the compositions of the present invention may optionally include adjuvants for the dissolution, emulsion or suspension of the compounds of Formula I. Likewise, this type of composition may also comprise other components such as wetting, solvent, humectant, dispersing, emulsifier, thickening, and chelating agents, other active principles with a similar or different effect than the compositions of the present invention, buffers, salts, sunscreens, waxes, penetration agents, covering agents and/or clays.

The compositions of the present invention may be solid or liquid compositions. The compositions may be powders, emulsifiable concentrates, concentrates for dilution, wettable powders, granules, suspension concentrates, diluted solutions, diluted dispersions and diluted suspensions, or combinations thereof. For the purpose of the invention, and without wishing to be limited, it is especially preferred to apply the compositions as a liquid, as this allows a higher penetration of the active compounds into the plant tissue, mostly in the case where the active compound is solubilized or is emulsified in a liquid carrier, preferably solubilized. Nevertheless, the liquid composition may be prepared from solid ingredients or mixtures, or from concentrate solutions just before application.

Surprisingly, the authors of the compositions of the present invention have found that only under certain circumstances the compounds of Formula I used in diluted formulations and applied according to the methods of the invention are able to cross the waxy layer that protects the plant, especially over fruit skins, and are also able to cross the cell membrane. Without losing generality, it is thought that this may be caused by the high concentration achieved for the active compounds solubilized in the compositions of the invention, and by the adjuvants included in the compositions, which keep active compounds in solution, in an optimal ionization state, and allow to achieve a good coverage of the plant parts when sprayed with the compositions of the invention. Especially, it has been proven that the use of a volatile pH buffer in order to keep a controlled pH in the composition (without losing generality, optimum pH for acid active compounds is around 6.0 in the diluted composition just before application) and the use of a wetting-humectant agent are relevant to achieve the effects of the compositions of the present invention.

The concentration ranges used for each of the compounds of Formula I in the diluted compositions of the invention that are directly applied to plants, vary from 0.01% to 20% by weight, especially from 1% to 15% by weight, preferably from 2% to 10% by weight, and most preferably from 2% to 5% by weight, based on the weight of the final diluted composition.

In molar concentrations, the ranges used for each of the compounds of Formula I in the diluted compositions of the invention that are directly applied to plants, vary from 1 to 200 mM, especially from 5 to 100 mM, preferably from 10 to 80 mM, and most preferably from 10 to 50 mM. As mentioned before, the diluted composition may comprise either mixtures of one or more compounds of Formula I in concentrations varying from 1 to 100 mM, from 5 to 80 mM, and from 10 to 60 mM each, and preferably in a concentration from 10 to 40 mM each, or mixtures with other agrochemical products wherein at least one compound of Formula I is present at said concentrations. These mixtures having the former concentrations may have been prepared either much before application or just before application, and the preparation procedure comprises mixing the active agent and at least one agrochemically acceptable vehicle.

Advantageously, the compositions of the present invention may be prepared as concentrated liquid solutions to be subsequently diluted, generally in water, just before application over plants. This concentrated composition must be suitable to allow subsequent dissolution, emulsion or suspension of the compound of Formula I, in such a way to obtain a diluted liquid with a suitable composition. The concentration of each compound of Formula I used in these concentrated compositions of the invention varies from 0.5% to 50%, especially from 1% to 30%, preferably from 5% to 30%, and more preferably from 10% to 30% based on the weight of the concentrated composition. In molar concentrations, the concentration ranges of each compound of Formula I used in these concentrated compositions of the invention varies from 0.05 to 5.00 mM, especially from 0.1 to 3.0 mM, preferably from 0.5 to 3 mM, and more preferably from 1 to 3 mM. The concentrated compositions may comprise all the components of the final diluted formulation, or they may comprise only some of the components, or even only the active compound of the invention, while the remaining components are mixed with the concentrated composition when preparing the diluted composition.

The solvent used for the dilution of the concentrated compositions may be the same solvent used in the preparation of said concentrated composition, or any other suitable solvent. The solvent for the liquid composition to be applied over plants is preferably water, optionally containing small amounts of other organic solvents to help solubilize, emulsify or suspend the compounds of Formula I. The solvents that can be used for the concentrated formulation of the invention may be any organic or inorganic solvent in which the compound of the invention is soluble in higher concentrations than the concentration of the solution to be applied over the plant, in such a way that the concentrated solution could be diluted before its application. Specifically, the solvent may be pure ethanol or water-ethanol mixtures or other pure or mixed organic solvent. The solvent may be any solvent used in the agrochemical industry to solubilize active compounds to be applied over a plant after dilution. For example, the solvent may be toluene, xylenes, dimethylsulfoxide, dimethylformamide, ethanol, methanol, acetone, ether, ethoxiethanol, methoxiethanol, or any other suitable solvent, alone or in mixture with other organic or inorganic solvent.

The concentrated compositions may also include other components other than the solvent and the compound of the invention. For example, the concentrated compositions may contain co-solvents, wetting, humectant, surfactant, dispersant, emulsifier, covering, thickening, and chelating agents, other active principles with the same effect of the compounds of the present invention or other effects, pH buffers, salts, sunscreens, waxes, penetration agents, clays, preserving and antioxidant agents, and the like.

The solvent used for dilution, preferably water, may also contain compounds that contribute additional effects to the diluted composition, as aforementioned, such as co-solvents, wetting, humectant, surfactant, dispersant, emulsifier, covering, thickening, and chelating agents, other active principles with the same effect of the compounds of the present invention or other effects, pH buffers, salts, sunscreens, waxes, penetration agents, clays, preserving and antioxidant agents, and the like.

For example, it has been found that a concentrated composition can be advantageously prepared by dissolving the active compounds of Formula I in an organic solvent, such as ethanol, dimethylformamide or dimethylsulfoxide, dissolving in water the remaining components of the diluted composition at their final concentration, and adding to this solution the concentrated composition with the compound of Formula I and the organic solvent just before application. In this way, an easy, fast and complete dissolution of the compound of Formula I is achieved, thus obtaining a diluted composition that allows the active compound to penetrate the wax layer that protects the plant and to achieve a complete effect after application.

In the other hand, the compositions of the invention may be applied by spraying, irrigation, fumigation, coverage, immersion or injection. The amount of composition required for an acre of land varies according to the selected application method. Nevertheless, it is preferable to use a direct application over the fruit to avoid unnecessary losses of the agrochemical preparation over the leaves and branches of the trees or into the soil, which is wetted when using, for example, a spraying machine.

The most suitable time to apply the compositions is during flower development or fruit development and growth, in one, two or more applications before harvest, and optionally in one, two or more additional applications after harvest.

It is preferable that applications could be temporally equally-spaced from the formation of fruit or flowers up to harvest and optionally leaving a last period before harvest with no application of the compositions.

In particular, it is preferable to carry out one, two or more applications, the first application between 6-8 weeks before harvest, and the second application between 3-4 weeks before harvest.

As previously mentioned, the compositions of the invention are useful for decreasing the incidence of damage caused by sun on plant tissues, especially damage caused by solar radiation and temperature, especially damage caused by UV radiation. Without losing generality, the compositions of the present invention cause a decrease of the damage caused by UV and temperature owing to an increase of the content of molecular species or compounds able to absorb UV radiation, visible radiation or both, and/or able to scavenge and/or stabilize free radicals in the surface of the plant, in the intercellular space (liquid) or in the intracellular space. This effect is due to the increase of concentration of polyphenolic compounds in the plant, such as phenols, acetophenones, phenolcarboxylic acids, phenylacetic acids, cinnamic acids, hydroxicinnamic acids, polypropenes, coumarins, isocoumarins, flavonoids, isoflavonoids, biflavonoids, quinones, tannins, lignans, neolignans, lignins, catecholmelanines, phenylpropanoids, stilbenes, phenylanthrenes, pterocarpanes and furocoumarins and the glycosylated and polymeric derivatives thereof. The preferred flavonoids are: anthocyanins, leucoanthocyanins, chalcones, aurones, flavones, isoflavones, flavans, isoflavans, flavonols, flavanols, isoflavonols, isoflavanols, dihydroflavonols, dihydroflavanols, flavanones, isoflavanones, dihydrochalcones, proanthocyanidins, catechins, biflavonoids and isoflavonoids.

Likewise, the compositions of the present invention are useful to alter the natural color of plant tissues, especially to achieve an increase of color; specifically red, violet, purple, blue, yellow, orange, and red-orange colors, and more specifically changes of color toward red, violet, purple or blue. Specifically, and without losing generality, the changes in color are related to an alteration of the contents or the proportion of flavonoid compounds in the plant, such as anthocyanins, leucoanthocyanins, chalcones, aurones, flavones, isoflavones, flavans, isoflavans, flavonoles, flavanols, isoflavonols, isoflavanols, dihydroflavonols, dihydroflavanols, flavanones, isoflavanones, dihydrochalcones, proanthocyanidins, catechins, biflavonoids and isoflavonoids, and the glycosylated derivatives thereof. More specifically, without losing generality, a color change is expected in flowers and/or fruits (inflorescences and/or infrutescences), especially in the pericarp and mesocarp.

Additionally, the compositions of the present invention alter the content of antioxidant species in plant tissues. Especially, an increase in the content of antioxidant species is expected, i.e. molecules able to scavenge and stabilize free radicals, turning them into unreactive species and thus blocking the generation chain of more free radicals. More specifically, an alteration or increase in the content of polyphenolic compounds is expected, especially flavonoids such as flavone, flavonol, 3′-hydroxiflavone, hispidol, chrisin, primetin, 7,4′-dihydroxiflavone, butein, sulfuretin, frutinone A, baicalein, 5-deoxikaempferol, galagin, norwogonin, tectochrisin, aurantinidin, aureusidin, maritimetin, 4,5-methylenedioxi-6-hydroxiaurone, phloridzin, phloretin, okanin, chrisin 5,7-dimethylether, datiscetin, fisetin, geraldone, wogonin, graveolin, 3-methylgalangin, 2′-hydroxipseudobaptigenin, 6-hydroxicyanidin, leptosidin, robinetin, japonin, baicalein 5,6,7-trimethylether, galangin 3,5,7-trimethylether, lunamarin, kinobscurinone, stealthin C, tetrangulol, phenanthroviridone aglycone, isobavachalcone, 8-O-methyltetrangulol, 19-hydroxitetrangulol, efloxate, glepidotin A, hypoxylone, 6-(3,3.dimethylallyl)-galangin, 8-(1,1-dimethylallyl)-galangin, 19-hydroxi-8-O-methyltetrangulol, dimefline hydrochloride, chlorflavonin, ficin, isoficin, 8-(3,3-dimethylallyl)-3-methylgalagin, 8-(1,1-dimethylallyl)-3-methylgalagin, skullcapflavone II, PD116740, diospirin, flavoxate, abisinone VI, 6,8-di-(3,3-dimethylallyl)-chrisin, 6-geranilchrisin, 8-geranilchrisin, tetracenomycins, carthamone, baicalin, knipholone, raloxifen, rottlerin, isobutrin, jadomycin B, actinorhodin, malvin, salvianin, 4′″-demalonylsalvianin, monardaein, conocurvone, anthocyanidins, anthocyanins, isoliquiritigenin, liquiritigenin, daidzein, 2′-hydroxidaidzein, formononetin, 2′-hydroxiformononetin, vestitone, medicarpin, maackiain, 4-hydroxihomopterocarpin, phaseolin, trifolirhizin, ferreirin, homoferreirin, toxicarol, sumatrol, dalpanin, pachirrhizone, millettone, deguelin, tephrosin, rotenone, 12A-hydroxirotenone, biochaninA, 2′-hydroxibiochaninA, genistein, 2′-hydroxigenistein, isoformononetin, calycosin, orobol, prunetin, pseudobaptigenin, texasin, afrormosin, bowdichione, cajanin, irilone, pratensein, sayanedin, tectorigenin, dehydroferreirin, irisolidone, wighteone, licoisoflavone A, luteone, 7-O-methyl-luteone, daidzin, osajin, puerarin, genistin, ononin, pomiferin, rotenonone, tectoridin, iridin, paniculatin, aurone, aureusidin, riccionidin A, bracteatin, isoetin, betulin, phloridzin, phloretin, naringenin-chalcone (isosalipurpol), eriodictyol-chalcone, homoeriodictyol-chalcone, pentahydroxiflavanone-chalcone, coreopsin, okanin, sigmoidin B, 5′-prenyl-homoeriodictyol, naringenin, eriodictyol, homoeriodictyol, pentahydroxiflavanone, hesperidin, hesperetin, apigenin, apiin, malonylapiin, acacetin, luteolin, 3′-O-methyl-luteolin, tricetin, apiforol, apigeninidin, luteoforol, luteolinidin, dihydrokaempferol (aromadendrin), dihydroquercetin (taxifolin), dihydromyricetin (ampelopsin), kaempferol, quercetin, myricetin, rutin, diosmin, leucocyanidin, leucopelargonidin, leucodelphinidin, leucopaeonidin, leucomalvidin, leucopetunidin, cyanidin, pelargonidin, delphinidin, paeonidin, malvidin, petunidin, kuromanin, callistephin, afzelechin, epiafzelechin, catechin, epicatechin, gallocatechin, epigallocatechin, cinchonain 1a, mahuanin D, gambiriin C, proanthocyanidins, fisetinidol, teasinensin A, kandelin A-1, silandrin, silimarin, eriocitrin, neoeriocitrin, 2,3-dihydrogossypetin, 6-methoxitaxifolin, 3-O-taxifolin acetate, astilbin (neoastilbin), silichristin, hesperidin, kolaflavanone, maniflavanone, neohesperidin, 6-hydroxicyanidin, rosinidin, capensinidin, hirsutidin, awobanin, malonylawobanin, gentiodelphin, 8-hydroxikaempferol, 6-hydroxikaempferol, 3-methoxiapigenin, kaempferide, morin, 3,3′,4′,5,7,8-hexahydroflavone, 3-O-methylquercetin, azaleatin, isorhamnetin, pinoquercetin, quercetagetin, rhamnetin, sexangularetin, tamarixetin, 3,7-di-O-methylquercetin, 3,3′,4′,5,7-pentahydroxi-6-methoxiflavone, patuletin, laricitrin, 3,7,4′-tri-O-methylquercetin, 3′,4′,5,6-tetrahydroxi-3,7-dimethoxiflavone, axilarin, pachyipodol, santin, tambulin, siringetin, 3-quercetin sulfate, 3′,4′,5-trihydroxi-3,6,7-trimethoxiflavone, 3′,4′,5-trihydroxi-3,7-dimethoxiflavone, chrysosplenol C, oxyayanin A, oxyayanin B, chrysosplenetin, veloquercetin, 8-(1,1-dimethylallyl)-kaempferide, 3,3′-quercetin bis-sulfate, lilalin, quercitrin, gossypetin, trifolin, isotrifolin, hyperin, myricitrin, quercimeritrin, 3,3′,7-quercetin tris-sulfate, 3,4′,7-quercetin sulfate, gossypin, sophoraflavonoloside, baimaside, robinin, 6-methoxiaromadendrin 3-O-acetate, phellamurin, sanggenon C, sanggenon D, vitexin, genkwanin, isoscutellarein, scutellarein, chrysoeriol, apigenin 7,4′-dimethylether, diosmetin, hispidulin, 6-hydroxiluteolin, hipolaetin, tricetin, pedalitin, cirsiliol, tricin, cirsilineol, eupatilin, nevadensin, acerosin, timonin. sinensetin, tangeretin, nobiletin, filospadin, morusin, isoorientin, orientin, isoscoparin, swertiajaponin, agatisflavone, amentoflavone, cupressuflavone, hinokiflavone, calycopterones, neoschaftoside, robustaflavone, schaftoside, carlinoside, neocarlinoside, violantin, saponarin, ginkgetin, vicenin-2, lucenin-2, sciadopitisin, kuwanone G, kuwanone H, the glycosylated, dimeric, trimeric and oligomeric derivatives thereof, and the like; quinones, phenols, phenolcarboxylic acids, hydroxicinnamic acids, tannins, stilbenes, phenylanthrenes, pterocarpans, phenylpropanoids, furocoumarins and the like.

In the other hand, the present invention also may improve the plant resistance against pests and pathogens. Specifically, the improved resistance is due to the increase in the concentration of polyphenolic compounds or their metabolic derivatives in plant tissues when subjected to a treatment as described, specifically, when this increase in resistance is accompanied by the changes (effects) previously mentioned. Especially, this increase in resistance is focused on a higher resistance against fungi, bacteria and insects attack.

Likewise, a higher resistance of the plant product treated as previously described against fungi, bacteria and insects after harvest and during storage, conservation and/or processing may be achieved. Specifically, this resistance is due to the accumulation (concentration) of polyphenolic compounds and/or metabolic derivatives thereof in the plant products treated as previously described, especially flavonoids, such as those mentioned before.

The present invention also provides functional foods that include a higher content of antioxidant species, especially polyphenols, flavonoids and anthocyanins, more specifically those polyphenolic and flavonoid derivatives mentioned above. Specifically, these functional foods are fruits and infrutescences, flowers and inflorescences and/or other plant parts obtained by means of the abovementioned procedures, i.e. flowers and inflorescences, fruits and infrutescences and/or other plant parts treated with the compositions of the invention that result in an increased content of antioxidant species, especially the polyphenolic compounds, flavonoids and anthocyanins mentioned previously.

The present invention is also related to plants, plant parts, fruits, flowers and/or propagating material treated with the compositions of the invention.

The present invention is illustrated by means of formulation examples and test examples, without limiting the scope and spirit of the present invention as it has been described.

### EXAMPLES

Different formulations were prepared to test the effects that said formulations have on Royal Gala apples during ripening. The compounds used for this were: caffeic acid, coumaric acid and ferulic acid. In a first example, a formulation was prepared (formulations A) that contained only ferulic acid, which was directly sprayed over the fruit in a single application, 5 weeks before harvest. In a second example, a second type of formulations (formulations B) were prepared, which contained one or more active compounds. In this second opportunity, these formulations were directly sprayed over the fruit twice, 7 and 3 weeks before harvest. In both cases, formulations were applied during morning hours, so the formulation could dry over the fruits before the hours of highest solar irradiation.

### Example 1

### Preparation of Diluted Formulations of Ferulic Acid

As previously mentioned, formulations containing only ferulic acid in a suitable range of working concentrations were prepared. For this, 3 diluted formulations were prepared (designated “formulations A”), each in a final volume of 0.5 liters. The first formulation, formulation A-I, contained a final concentration of 10 mM ferulic acid, the second formulation, formulation A-II, contained a final concentration of 20 mM ferulic acid, and the last formulation, formulation A-III, contained a final concentration of 40 mM ferulic acid. The composition of the final diluted formulations is shown in the following table.

TABLE 4
COMPOSITION OF DILUTED FORMULATIONS A

| | A-I | A-II | A-III |
|---|---|---|---|
| Ferulic acid | 10 mM | 20 mM | 40 mM |
| Ethanol | 100 ml | 100 ml | 100 ml |
| Zoom 50 ® | 0.25 ml | 0.25 ml | 0.25 ml |
| KH₂PO₄ | 50 mM | 50 mM | 50 mM |
| Water | 400 ml | 400 ml | 400 ml |

Formulations A-I, A-II and A-III were prepared as follows. First, equal suitable amounts of water and pure ethanol (Merck S.A., Santiago, Chile) were mixed to form a 20% ethanol-water solution. In this mixture, a suitable amount of KH₂PO₄ (Merck S.A., Santiago, Chile) was dissolved to obtain a 50 mM KH₂PO₄ solution in 20% ethanol. To 500 ml of this solution 0.25 ml of Zoom 50 (commercially available from ANASAC, S.A.C.I., Santiago, Chile) was added. Zoom 50® is a non-ionic surfactant co-adjuvant that acts as humectant-adherent and emulsifier agent. Zoom 50® is composed by alkylphenol ether and polyethyleneglycol, with a concentration of 440 g/l. For the purposes of this invention, it has been found that the use of said surfactant agent allows a better application and a better penetration of the active compounds in the tissues of treated plants, as explained above. Finally, to 500 ml of the resulting solution a suitable amount of 99.5% ferulic acid (Sigma-Aldrich Co., St. Louis, Mo.) was added to achieve the desired concentration for each formulation. The resulting suspension was stirred until completely dissolving the solid ferulic acid at room temperature (10 minutes), with no additional heating to avoid inducing degradative processes. These formulations were applied over treated plant parts by spraying, achieving a total coverage of the treated parts.

### Example 2

### Preparation OF Concentrated Formulations of Ferulic Acid, P-Coumaric Acid and Caffeic Acid and Mixtures of Ferulic and P-Coumaric Acids and Caffeic and P-Coumaric Acids

Subsequently, a new set of formulations was prepared (designated “formulations B”), which include mixtures of some active compounds of the invention. The formulations also comprise different concentration levels for the active compounds used alone or as part of a mixture. As a comparative reference with respect to the previous set of formulations (formulations A), a formulation including only ferulic acid in two different concentrations was used. Formulations B were initially prepared as concentrated solutions of the compound(s) of the invention in a suitable solvent. In Formulations B, dimethylformamide (DMF) was used as the solvent in an amount slightly in excess over the amount required to solubilize the required amount of active compound, without heating. In this way, the desired final concentration could be obtained by suitably diluting the concentrated solution before application.

To prepare the required concentrated solution to obtain 500 ml of diluted solution in each case, an appropriate amount of the active compound(s) was mixed with 7 ml of dimethylformamide. The resulting suspension was stirred for a time enough to achieve complete dissolution of the active compound(s) at room temperature (10 minutes), without additional heating to avoid inducing degradative processes.

Following this procedure, the concentrated formulation mixtures of Table 5 were prepared. Although an equal amount of solvent (DMF) was always used in the example shown with the purpose of comparing the different effects of each formulation on the fruit, the amount of solvent might be suitably varied for each of the formulations, according to the requirements of each case.

TABLE 5
CONCENTRATED FORMULATION

| | Formulation | | | | | | | |
|---|---|---|---|---|---|---|---|---|
| Compound | B-I | B-II | B-III | B-IV | B-V | B-VI | B-VII | B-VIII |
| Ferulic ac. (g) | — | 1.9420 | — | — | 3.8840 | — | 1.9420 | — |
| p-Coumaric ac. (g) | 1.6416 | — | — | 3.2832 | — | — | 1.6416 | 1.6416 |
| Caffeic ac. (g) | — | — | 1.8016 | — | — | 3.6032 | — | 1.8016 |
| DMF (ml) | 7.0 | 7.0 | 7.0 | 7.0 | 7.0 | 7.0 | 7.0 | 7.0 |

This new set of formulations was immediately diluted in a carrier liquid that contained the remaining components of the formulation, as exposed in the following Example, just before spraying them over apples.

### Example 3

### Preparation of Dilution Liquid and Diluted Formulations of Ferulic Acid, P-Coumaric Acid and Caffeic Acid and Mixtures of Ferulic and P-Coumaric Acids and Caffeic and P-Coumaric Acids from Concentrated Solutions

The concentrated Formulations B of Table 5 were diluted immediately before application in a dilution liquid prepared from the components and with the proportions indicated in Table 6. The dilution liquid comprises a humectant-adherent and emulsifying agent (Zoom 50®, from ANASAC S.A.C.I., Santiago, Chile), that allows also a better penetration of the active compounds in the plant tissues, and a volatile pH buffer (ammonium bicarbonate), both solubilized in water.

TABLE 6
FORMULATION OF THE DILUTION LIQUID

| Compound | Amount |
|---|---|
| Zoom 50 ® | 0.25 ml |
| (NH₄)HCO₃ | 3.45 g |
| Water | Up to 500 ml |

The dilution liquid was prepared by dissolving 3.45 g of ammonium bicarbonate in 450 ml of water, with stirring. Once the solid completely dissolved, 0.25 ml of Zoom 50 were added and the solution was homogenized during 1 additional minute. Finally, water was added in a sufficient amount to reach 500 ml.

Using this dilution liquid that contributes the remaining components of Formulations B, a diluted solution was prepared, with the suitable volume proportion between the concentrated formulation and the dilution liquid indicated in Table 7. For this, the entire concentrated solution previously prepared was used and dilution liquid was added up to 500 ml, just before application by spraying over the plants, looking for a total coverage of the treated parts.

TABLE 7
PREPARATION OF THE DILUTED FORMULATION FOR
APPLICATION

| Solution | Volume (ml) |
|---|---|
| Concentrated formulation | 7-12 |
| Dilution liquid | up to 500 ml |

In this way, the final composition of each of the diluted formulations used in the present Example to be applied directly over the plants is presented in Table 8.

TABLE 8
COMPOSITION OF DILUTED FORMULATIONS B

| | Formulation | | | | | | | |
|---|---|---|---|---|---|---|---|---|
| Component | B-I | B-II | B-III | B-IV | B-V | B-VI | B-VII | B-VIII |
| Ferulic ac. | — | 20 | — | — | 40 | — | 20 | — |
| (mM) | | | | | | | | |
| p-Coumaric ac. | 20 | — | — | 40 | — | — | 20 | 20 |
| (mM) | | | | | | | | |
| Caffeic ac. | — | — | 20 | — | — | 40 | — | 20 |
| (mM) | | | | | | | | |
| DMF (ml) | 7.0 | 7.0 | 7.0 | 7.0 | 7.0 | 7.0 | 7.0 | 7.0 |
| Zoom 50 ® | 0.5 | 0.5 | 0.5 | 0.5 | 0.5 | 0.5 | 0.5 | 0.5 |
| (% v/v) | | | | | | | | |
| Ammonium | 100 | 100 | 100 | 100 | 100 | 100 | 100 | 100 |
| bicarbonate | | | | | | | | |
| (mM) | | | | | | | | |
| Water | up to | up to | up to | up to | up to | up to | up to | up to |
| | 500 ml | 500 ml | 500 ml | 500 ml | 500 ml | 500 ml | 500 ml | 500 ml |

### Example 4

### Preparation of Diluted Formulations of Ferulic Acid Containing Another Agrochemical Product

A new set of formulations was also prepared (designated “formulations C”), said formulations including mixtures of an active compound of the invention and other agrochemical compounds. The active compound selected for these formulations was ferulic acid, which was combined in a first formulation (designated “Formulation C-I”) with a fungicide (tebuconazole), and in a second formulation (designated “Formulation C-II”) with an insecticide (diazinon). As a comparative reference for the effect of ferulic acid with this two agrochemical compounds, previously described Formulation B-II, which contained 20 mM ferulic acid, was used.

Diluted formulations C were prepared from the concentrated solutions previously prepared according to the method of Example 2, using a suitable amount of ferulic acid dimethylformamide. Concentrated formulations were diluted in the dilution liquid described in Example 3. An appropriate amount of the corresponding additional agrochemical compound contained in a suitable commercial formulation was added to the obtained solution. The obtained solution was immediately applied by spraying over the plants looking for a total coverage of the treated parts, including leaves and branches to keep the effect of the other agrochemical components.

Suitable commercial formulations were used to prepare Formulations C. TACORA 25 WP, a wettable powder formulation including 25% by weight of tebuconazole (ANASAC S.A.C.I., Santiago, Chile), was used to include tebuconazole in the formulation, while DIAZINON 40 WP, a commercial formulation including 40% by weight of diazinon (ANASAC S.A.C.I., Santiago, Chile), was used to include diazinon in the mixture. The commercial formulations of said products were used according to the manufacturer's indications for each corresponding product.

In this way, the final composition of each of the diluted formulations used in the present Example that were applied directly over the plants is presented in Table 9.

TABLE 9
COMPOSITION OF DILUTED FORMULATIONS C

| | Formulation | |
|---|---|---|
| Component | C-I | C-II |
| Ferulic ac. | 20− | 20 |
| (mM) | | |
| Tacora 25 WP (g) | 0.2 | |
| | (equivalent to 0.05 | — |
| | g of tebuconazole) | |
| Diazinon 40 WP (g) | — | 0.6 |
| | | (equivalent to 0.24 |
| | | g of diazinon) |
| DMF (ml) | 7.0 | 7.0 |
| Zoom 50 ® (% v/v) | 0.5 | 0.5 |
| Ammonium bicarbonate | 100 | 100 |
| (mM) | | |
| Water | up to 500 ml | up to 500 ml |

### Example 5

### Results of the Application of the Formulations Over Royal GALA Apples

Results for Formulations A.

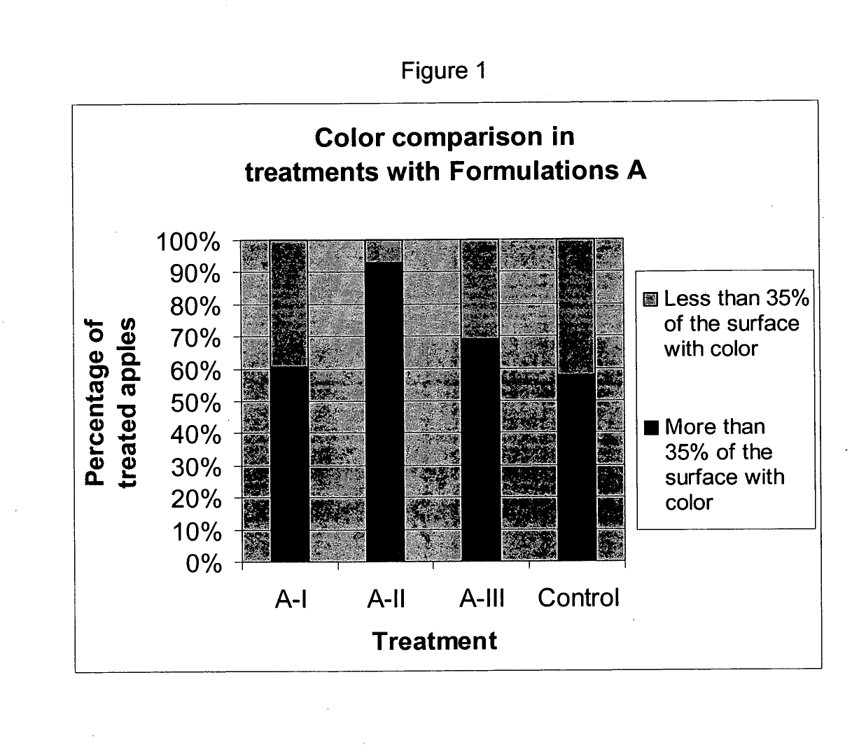

Many concentrations of ferulic acid were initially tested to determine a concentration range that was interesting for the preparations of the present invention. Formulation A-I was prepared including 10 mM ferulic acid, Formulation A-II including 20 mM ferulic acid, and Formulation A-III including 40 mM ferulic acid. All Formulations A were compared with a “control” formulation that did not contain ferulic acid or any other active compound described in the present invention, but including the remaining components of Formulations A in the abovementioned concentrations. In FIG. 1, results are shown for fruit color when using each of the three formulations. For the purpose of analyzing the obtained results, an acceptable fruit color was defined as red color covering more than 35% of the total surface of the apple.

Obtained results, expressed as percentage based on treated apples, are shown in FIG. 1 and in Table 10.

TABLE 10
SUMMARY FOR COLOR RESULTS
Summary table for color results

| Level | >35% | <35% |
|---|---|---|
| Formulation A-I | 61% | 39% |
| Formulation A-II | 93% | 7% |
| Formulation A-III | 69% | 31% |
| Control | 58% | 42% |

Regarding the obtained results, it can be observed that:
Formulation A-I had little effect to improve the color
Formulation A-II produced an increase of more than 30% of well-colored apples, i.e. apples having more than 35% of their surface covered with red color, and a related reduction of poorly-colored apples.
Formulation A-III produced a moderate increase in apple color.

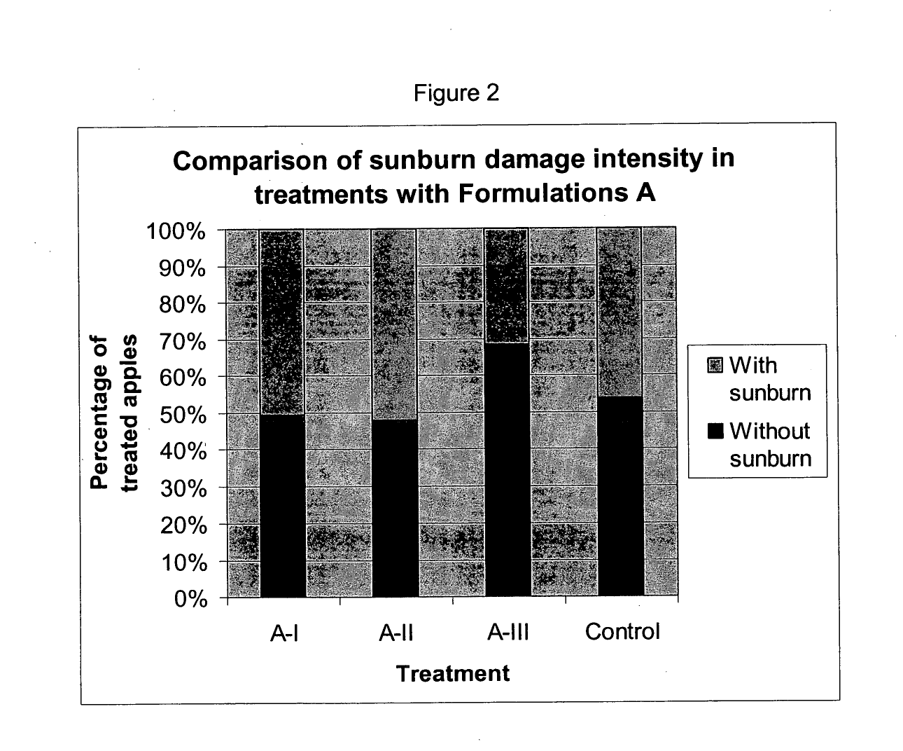

When all three Formulations A were assessed as protectants against sunburn damage intensity, the obtained results are shown in FIG. 2 and in Table 11, expressed as percentage based on treated apples.

TABLE 11
SUMMARY OF RESULTS FOR SUNBURN DAMAGE INTENSITY
Summary table of results for
sunburn damage intensity

| Level | No damage | Damaged |
|---|---|---|
| Formulation A-I | 49% | 51% |
| Formulation A-II | 48% | 52% |
| Formulation A-III | 68% | 32% |
| Control | 54% | 46% |

Regarding the obtained results, it can be observed that:
Formulations A-I and A-II were not significantly effective to reduce sunburn intensity.

Formulation A-III produced a moderate increase in the percentage of apples with no sunburn damage.

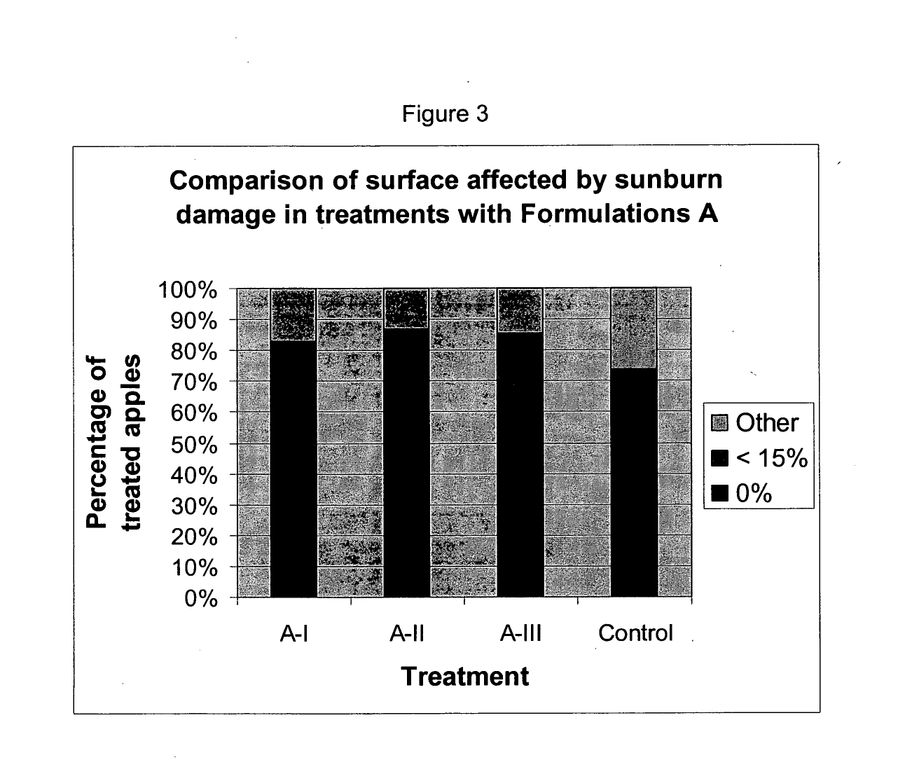

Likewise, FIG. 3 and Table 12 show the results of the tests performed with Formulations A to assess their effectiveness to decrease the total apple surface affected by sunburn damage. The results are shown as percentage based on treated apples, by categorizing results in three classes according to the total percentage of surface affected: 0% damaged surface (Nothing), less than 15% damaged surface (Slight) and more than 15% of damaged surface (Remainder). Furthermore, the sum of apple percentages without sunburn damage and with little surface damage caused by sunburn (Nothing+Slight) is shown.

TABLE 12
SUMMARY OF RESULTS FOR TOTAL SURFACE AFFECTED BY
SUNBURN DAMAGE
Summary table of results for total surface affected by sunburn damage

| | 0% | | (Nothing + | |
|---|---|---|---|---|
| Level | (Nothing) | (Slight) | Slight) | Remainder |
| Formulation A-I | 49% | 34% | 83% | 17% |
| Formulation A-II | 48% | 39% | 87% | 13% |
| Formulation A-III | 68% | 17% | 85% | 15% |
| Control | 54% | 20% | 74% | 26% |

Regarding the obtained results, it can be observed that:
Formulations A-I, A-II and A-III produce a moderate decrease of the surface damaged by sunburn. In the cases when said formulations does not avoid sunburn occurrence, they protect against sunburn damage extended over more than 15% of the fruit surface.

To determine whether the desired effects are produced by the applied formulations and not due to random effects, the obtained results were subjected to 3 different statistical tests: χ² analysis for homogeneity or independence, Mann-Whitney-Wilcoxon test for independence (MWW) and Kolmogorov-Smirnov test for independence (KS). In the following Table 13, the summary of results for Formulations A for the three studied characteristics (increased color, decreased sunburn damage intensity and decreased surface affected by sunburn damage) and the statistical validity found for each treatment with respect to the control are shown.

TABLE 13
SUMMARY OF RESULTS OF STATISTICAL TESTS FOR THE
SIGNIFICANCE OF THE TREATMENTS
Levels of significance (p) of the population equality hypothesis

| | Statistical test | | |
|---|---|---|---|
| Formulation | χ² | MWW | KS |

Color

| | | | |
|---|---|---|---|
| Formulation A-I | <0.01 | 0.09 | n.s. |
| Formulation | <0.01 | <0.01 | <0.01 |
| A-II | | | |
| Formulation | <0.01 | 0.02 | <0.01 |
| A-III | | | |

Intensity

| | | | |
|---|---|---|---|
| Formulation A-I | <0.01 | 0.06 | n.s. |
| Formulation | <0.01 | 0.03 | <0.1 |
| A-II | | | |
| Formulation | <0.01 | <0.01 | <0.01 |
| A-III | | | |

Surface

| | | | |
|---|---|---|---|
| Formulation A-I | <0.01 | n.s. | n.s. |
| Formulation | <0.01 | n.s. | <0.05 |
| A-II | | | |
| Formulation | <0.01 | <0.01 | <0.01 |
| A-III | | | |

n.s.: non significant

The statistical validity of the differences detected when applying the different treatments over the fruit and the improvement obtained from the use of said treatments is thus demonstrated.

Results for Formulations B.

Given that the concentrations required to achieve a good color are different than those required to obtain a good protection against sunburn damage when using compositions that use only ferulic acid, a new set of formulations (Formulations B) were designed to improve the observed results. The new set of formulations also compared the effects and properties of p-coumaric, caffeic and ferulic acids either individually or in combination at 20 mM and 40 mM concentrations, in order to determine their ability to improve color and to quantify their efficiency to decrease the intensity and extension of sunburn damage. Therefore, Formulation B-I including 20 mM p-coumaric acid, Formulation B-II including 20 mM ferulic acid, Formulation B-III containing 20 mM caffeic acid, Formulation B-IV containing 40 mM p-coumaric acid, Formulation B-V including 40 mM ferulic acid, Formulation B-VI containing 40 mM caffeic acid, Formulation B-VII including a mixture of p-coumaric and ferulic acids 20 mM each, and Formulation B-VIII containing a mixture of p-coumaric and caffeic acids 20 mM each were prepared.

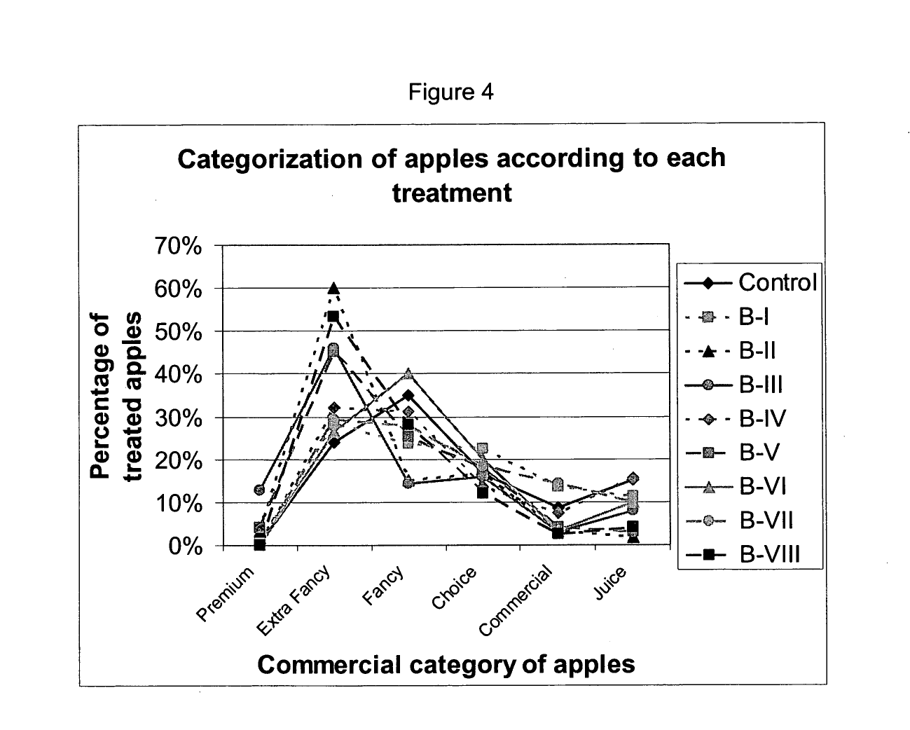

The effects of Formulations B-I to B-VIII over apple categorization and commercial valuation when compared to a control formulation that do not contain any of the active compounds described by the present invention, but including the remaining components at the same concentration, were assessed. The commercial categories of apples according to their color, form, lack of russet and lack of visible damage are: Juice, Commercial, Choice, Fancy, Extra Fancy and Premium, being Juice the category corresponding to worst color and lower price and Premium the apple with best color and higher price. The results obtained for the categorization change of apples are shown in FIG. 4 and Table 14.

TABLE 14
RESULTS FOR THE COMMERCIAL CATEGORIZATION OF
APPLES OBTAINED WHEN USING FORMULATIONS B
Category

| | | Extra | | | | |
|---|---|---|---|---|---|---|
| Product | Premium | Fancy | Fancy | Choice | Commercial | Juice |
| Control | 0.6% | 23.9% | 35.0% | 16.7% | 8.7% | 15.1% |
| B-I | 0.7% | 28.4% | 23.9% | 22.4% | 13.4% | 11.2% |
| B-II | 3.3% | 60.0% | 15.0% | 16.7% | 3.3% | 1.7% |
| B-III | 12.7% | 46.0% | 14.3% | 15.9% | 3.2% | 7.9% |
| B-IV | 0.0% | 32.3% | 31.3% | 13.5% | 7.3% | 15.6% |
| B-V | 4.2% | 45.3% | 25.3% | 17.9% | 4.2% | 3.2% |
| B-VI | 0.0% | 26.7% | 40.0% | 20.0% | 3.3% | 10.0% |
| B-VII | 0.0% | 29.4% | 27.9% | 18.4% | 14.4% | 10.0% |
| B-VIII | 0.0% | 53.3% | 28.0% | 12.0% | 2.7% | 4.0% |

From the former data, it is possible to conclude that:
The application of these Formulations produces a systematic increase of the proportion of Extra Fancy and Premium apples, i.e. the proportion of apples with a desirable color and without sunburn damage increases.
The best results are obtained with the formulations that include ferulic acid and caffeic acid alone, and with the mixture of p-coumaric and caffeic acids, Formulations B-II, B-III and B-VIII, respectively.
Medium concentrations (20 mM) resulted more effective than high concentrations (40 mM).

Results for Formulations C.

To exemplify the use of formulations of the invention that contain other agrochemical products, Formulations C were prepared and applied over apples as in the Examples above. The result of the effect over commercial categorization of apples of this assay was compared with the result obtained for Formulation B-II. Additionally, the fungicide effect or insecticide effect of the additional compound in the presence of ferulic acid was compared, using a control formulation without ferulic acid as a reference, but containing all the remaining components of the corresponding Formulation C, specifically the corresponding additional agrochemical compound.

The effect of Formulations C-I and C-II on the commercial categorization of apples was studied as for Formulations B. The results of this assay were the following:
No significant differences between the results of commercial categorization of apples given by Formulations C-I and C-II and those produced by Formulation B-II, according to a χ² analysis for homogeneity or independence, a Mann-Whitney-Wilcoxon test for independence (MWW) and a Kolmogorov-Smirnov test for independence (KS). Therefore, the effect of the compound of the invention is not altered by the presence of other agrochemical compounds.
Additionally, no significant differences were assessed for the effectiveness of the other agrochemical compounds when composing the formulation of the invention, in comparison with a control formulation that did not contain the compound of the invention.

1. An agrochemical composition wherein said composition comprises at least one compound of Formula I: 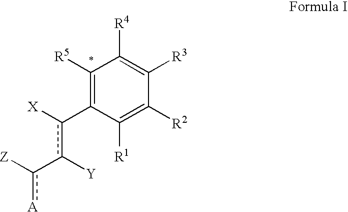
and the salts, esters, ethers, solvates or isomers thereof, or their corresponding O- and/or N-glycosides; wherein R¹ to R⁴ are independently selected from the group consisting of hydrogen, halogen, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O), —OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, NO₂, —NO, —NH—NH₂, —NH—NHR⁶, —NH—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS, —SCN, an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O)ₙR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, NO₂, —NO, —NH—NH₂, —NH—NHR⁶—NH—NR⁶R⁷, —NHOH, —NR⁶OH, —NHOR⁶, OR⁷, —N₂⁺, —N═NH, —N═NR⁶, —N═NOH, —N═NOR⁶, —N₃, —CN, —CNS or —SCN;
R⁵ can be either the same as described for R¹ to R⁴ or it can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
R⁶ and R⁷ are independently selected from the group consisting of an alkyl, alkenyl, alkynyl, cycloalkyl, cycloalkenyl, cycloalkynyl, heterocycloalkyl, heterocycloalkenyl, heterocycloalkynyl, aryl, heteroaryl, organometallic, O-glycosyl or N-glycosyl group, which can be also substituted with one or more independently selected R⁹ groups;
R⁸ is ═O, ═S, ═NH, ═NR⁶, ═CH₂, ═CHR⁶, ═CR⁶R⁷;
R⁹ is selected from the group consisting of hydrogen, halogen, —OH, —OR¹⁰, —NH₂, —NHR¹⁰, —NR¹⁰R¹¹, —N═R¹², —C(═O)OH, —C(═O)OR¹⁰, —OS(═O)ₙOH, —OS(═O)ₙOR¹⁰, —S(═O)ₙOH, —S(═O)ₙOR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, —PR¹⁰R¹¹, —PO₂, —PO, —P═R¹², —NO₂, —NO, —NH—NH₂, —NH—NHR¹⁰, —NH—NR¹⁰R¹¹, —NHOH, —NR¹⁰OH, —NHOR¹⁰, —NR¹⁰OR¹¹, —N₂⁺, —N═NH, —N═NR¹⁰, —N═NOH, —N═NOR¹⁰, —N₃, —CN, —CNS, —SCN, an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroalyl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R¹⁰, —OH, —OR¹⁰, —NH₂, —NHR¹⁰, —NR¹⁰R¹¹, —N═R¹², —C(═O)OH, —C(═O)OR¹⁰, —OS(═O)ₙOH, —OS(═O)ₙOR¹⁰, —S(═O)ₙOH, —S(═O)ₙOR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, —PR¹⁰R¹¹, —PO₂, —PO, —P═R¹², —NO₂, —NO, —NH—NH₂, —NH—NHR¹⁰, —NH—NR¹⁰R¹¹, —NHOH, —NR¹⁰H, —NHOR¹⁰, —NR¹⁰OR¹¹, —N₂⁺, —N═NH, —N═NR¹⁰, —N═NOH, —N═NOR¹⁰, —N₃, —CN, —CNS or —SCN;
R¹⁰ and R¹¹ are independently selected from the group consisting of an alkyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, an organometallic group, an O-glycosyl group or an N-glycosyl group.
R¹² is ═O, ═S, ═NH, ═NR¹⁰, ═CH₂, ═CHR¹⁰, ═CR¹⁰R¹¹;
X, Y and Z are independently selected from the group consisting of hydrogen, an allyl group, an alkenyl group, an alkynyl group, a cycloalkyl group, a cycloalkenyl group, a cycloalkynyl group, a heterocycloalkyl group, a heterocycloalkenyl group, a heterocycloalkynyl group, an aryl group, a heteroaryl group, halogen, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O)ₙOR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —NH—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS, SCN, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O)ₙOR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —NH—NR⁶R⁷, —NHOH, —NR⁶OH, —NHOR⁶, —NR⁶OR⁶, —N₂⁺, —N═NH, —N═NR⁶, —N═NOH, —N═NOR⁶, —N₃, —CN, —CNS or —SCN; wherein X and Z could be bound forming a 5- to 7-membered ring, which could also be substituted with one or more independently selected R⁶ groups and/or could be part of a fused ring system, optionally substituted with one or more independently selected R⁹ groups; or R⁵ can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
A is hydrogen, ═O, ═S, ═NH, ═NR⁶, ═CH₂, ═CHR⁶, ═CR⁶R⁷, halogen, —OH, —OR⁶, —NH₂, —NHR⁶, —NR⁶R⁷, —N═R⁸, —C(═O)OH, —C(═O)OR⁶, —OS(═O)ₙOH, —OS(═O)ₙOR⁶, —S(═O)ₙOH, —S(═O)ₙOR⁶, —SH, —SR⁶, —C(═O)H, —C(═O)R⁶, —OP(═O)(OH)₂, —OP(═O)(OH)(OR⁶), OP(═O)(OR⁶)(OR⁷), —PH₂, —PHR⁶, —PR⁶R⁷, —PO₂, —PO, —P═R⁸, —NO₂, —NO, —NH—NH₂, —NH—NHR⁶, —N—NR⁶R⁷, —NHOH, —NR⁶OH, —NHOR⁶, —NR⁶OR⁷, —N₂⁺, —N═NH, —N═NR⁶, —N═NOH, —N═NOR⁶, —N₃, —CN, —CNS, —SCN, an organometallic group, an O-glycosyl group or a N-glycosyl group;
n is 0, 1 or 2;
a discontinuous line parallel to a continuous line represents an optional double bond;
with the proviso that all R¹ to R⁵ groups were simultaneously hydrogen, or at least one group R¹ to R⁵ must be —OH, —OCH₃, —NH₂, —NHR⁶, —NR⁶R⁷, O-glycosyl or N-glycosyl and at least one agrochemically acceptable vehicle.

2. The agrochemical composition of claim 1 wherein said composition comprises at least one compound of Formula II: 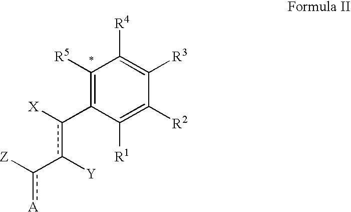
and the salts, esters, ethers, solvates or isomers thereof, or their corresponding O- and/or N-glycosides; wherein R¹ to R⁴ are independently selected from the group consisting of hydrogen, halogen, —OH, —OR⁶, —NH₂, —NHR⁶, —NR⁶R⁷, —N═R⁸, —C(═O)OH, —C(═O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS, —SCN, a C₁-C₇ alkyl group, a C₂-C₇ alkenyl group, a C₂-C₇ alkynyl group, a C₃-C₁₁ cycloalkyl group, a C₄-C₁₁ cycloalkenyl group, a C₄-C₁₁ cycloalkynyl group, a 4- to 11-membered heterocycloalkyl group, a 4- to 11-membered heterocycloalkenyl group, a 4- to 11-membered heterocycloalkynyl group, an aryl group, a heteroaryl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁶, —N═R⁷, —C(═O)OH, —C(═O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₇, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS or —SCN;
R⁵ can be either the same as described for R¹ to R⁴ or it can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
R⁶ and R⁷ are independently selected from the group consisting of a C₁-C₄ alkyl, C₂-C₄ alkenyl, C₂-C₄ alkynyl, C₃-C₆ cycloalkyl, C₄-C₆ cycloalkenyl, C₄-C₆ cycloalkynyl, 3- to 6-membered heterocycloalkyl, 4- to 6-membered heterocycloalkenyl, 4- to 6-membered heterocycloalkynyl, aryl, heteroaryl, organometallic, O-glycosyl or N-glycosyl group, which can be also substituted with one or more independently selected R⁹ groups;
R⁸ is ═O, ═S, ═NH, ═NR⁶, ═CH₂, ═CHR⁶, CR⁶R⁷;
R⁹ is selected from the group consisting of hydrogen, halogen, —OH, —OR¹⁰, —NH₂, —NHR¹⁰, —NR¹⁰R¹¹, —N═R¹², —C(═O)OH, —C(═O)OR¹⁰, —S(═O)₂OH, —S(═O)₂OR¹⁰, —SH, SR¹⁰, —C(═O)H, —C(═O)R¹⁰, —OP(═O)(OH)₂, OP(═O)(OH)(OR¹⁰), —OP(═O)(OR¹⁰)(OR¹¹), —PH₂, —PHR¹⁰, —PR¹⁰R¹¹, —NO₂, —NO, —NH—NH₂, —NH—NHR¹⁰, —NH—NR¹⁰R¹¹, —NHOH, —NR¹⁰OH, —NHOR¹⁰, —NR¹⁰OR¹¹, —N═NH, —N═NR¹⁰, —N═NOH, —N═NOR¹⁰, —N₃, —CN, —CNS, —SCN, a C₁-C₄ alkyl group, a C₂-C₄ alkenyl group, a C₂-C₄ alkynyl group, a C₃-C₆ cycloalkyl group, a C₄-C₆ cycloalkenyl group, a C₄-C₆ cycloalkynyl group, a 3- to 6-membered heterocycloalkyl group, a 4- to 6-membered heterocycloalkenyl group, a 4- to 6-membered heterocycloalkynyl group, an aryl group, a heteroalyl group, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R¹⁰, —OH, —OR¹⁰, —NH₂, —NHR¹⁰, —NR¹⁰R¹¹, —N═R¹⁰, —C(═O)OH, —C(═O)OR¹⁰, —S(═O)₂OH, —S(═O)₂OR¹⁰, —SH, —SR¹⁰, —C(═O)H, —C(═O)R¹⁰, —OP(═O)(OH)₂, —OP(═O)(OH)(OR¹⁰), —OP(═O)(OR¹⁰)(OR¹¹), —PH₂, —PHR¹⁰, —PR¹⁰R¹¹, —NO₂, —NO, —NH—NH₂, —NH—NHR¹⁰, —NH—NR¹⁰OR¹¹, —NHOH, —NR¹⁰OH, —NHOR¹⁰, —NR¹⁰R¹¹, —N═NH, —N═NR¹⁰, —N═NOH, —N═NOR¹⁰, —N₃, —CN, —CNS or —SCN;
R¹⁰ and R¹¹ are independently selected from the group consisting of a C₁-C₄ alkyl, C₂-C₄ alkenyl, C₂-C₄ alkynyl, C₃-C₆ cycloalkyl, C₄-C₆ cycloalkenyl, C₄-C₆ cycloalkynyl, 3- to 6-membered heterocycloalkyl, 4- to 6-membered heterocycloalkenyl, 4- to 6-membered heterocycloalkynyl, aryl, heteroaryl, organometallic, O-glycosyl or N-glycosyl group;
X, Y and Z are independently selected from the group consisting of hydrogen, a C₁-C₇ alkyl group, a C₂-C₇ alkenyl group, a C₂-C₇ alkynyl group, a C₃-C₁₁ cycloalkyl group, a C₄-C₁₁ cycloalkenyl group, a C₄-C₁₁ cycloalkynyl group, a 3- to 11-membered heterocycloalkyl group, a 4- to 1-membered heterocycloalkenyl group, a 4- to 11-membered heterocycloalkynyl group, an aryl group, a heteroaryl group, halogen, —OH, —OR⁶, —NH₂, —NHR⁶, —NR⁶R⁷, —N═R⁸, —C(═O)OH, —C(═O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS, —SCN, an organometallic group, an O-glycosyl group or a N-glycosyl group. Any of these aforementioned alkyl, alkenyl, alkynyl, cycloalkyl, cycloalkenyl, cycloalkynyl, heterocycloalkyl, heterocycloalkenyl, heterocycloalkynyl, aryl and heteroaryl groups can be optionally and independently substituted with one or more substituents selected from the group consisting of halogen, —R⁶, —OH, —OR⁶, —NH₂, —NHR⁶, —NR⁶R⁷, —N═R⁸, —C(═O)OH, —C(═O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —NH—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS or —SCN; wherein X and Z could be bound forming a 5- to 7-membered ring, which could also be substituted with one or more independently selected R⁹ groups and/or could be part of a fused ring system, optionally substituted with one or more independently selected R⁹ groups; or R⁵ can be absent and Z could be directly bound to the carbon atom indicated in Formula I with an asterisk, thus forming a 5- to 7-membered ring, which could also be substituted with one or more independently selected R⁹ groups and/or could be part of a fused ring system, optionally substituted with one or more independently selected R⁹ groups;
A is hydrogen, ═O, ═S, ═NH, ═NR⁶, ═CH₂, ═CHR⁶, ═CR⁶R⁷, halogen, —OH, —OR⁶, —NH₂, —NHR⁶, —NR⁶R⁷, —N═R⁷, —C(═O)OH, —C(═O)OR⁶, —S(═O)₂OH, —S(═O)₂OR⁶, —SH, —SR⁶, —C(═O)H, —C(═O)R⁶, —OP(═O)(OH)₂, —OP(═O)(OH)(OR⁶), —OP(═O)(OR⁶)(OR⁷), —PH₂, —PHR⁶, —PR⁶R⁷, —NO₂, —NO, —NH—NH₂, —NH—NHR⁶, —N—NR⁶R⁷, —NHOH, —NR⁶OH, —NHOR⁶, —NR⁶OR⁷, —N═NH, —N═NR⁶, —N═NOH, —N═NOR⁶, —N₃, —CN, —CNS, —SCN, an organometallic group, an O-glycosyl group or a N-glycosyl group;
a discontinuous line parallel to a continuous line represents an optional double bond;
with the proviso that all R¹ to R⁵ groups were simultaneously hydrogen, or at least one group R¹ to R⁵ must be —OH, —OCH₃, —NH₂, —NHR⁶, —NR⁶R⁷, O-glycosyl or N-glycosyl
and at least one agrochemically acceptable vehicle.

3. The agrochemical composition of claim 1 wherein said composition comprises at least one compound of Formula III: 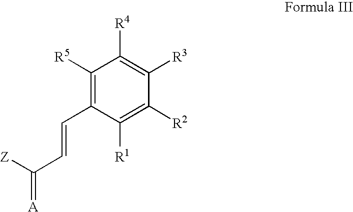
and the salts, esters, ethers, solvates or isomers thereof, or their corresponding O- and/or N-glycosides; wherein R¹ to R⁵ are independently selected from the group consisting of hydrogen, —OH, —OR⁶, —NH₇, —NHR⁶, —NR⁶R⁷, an O-glycosyl group or a N-glycosyl group;
R⁶ and R⁷ are independently selected from the group consisting of a C₁-C₃ alkyl, C₂ alkenyl, C₂ alkynyl, O-glycosyl or N-glycosyl group;
Z is selected from the group consisting of hydrogen, —OH, —OR⁶, —NH₂, —NHR⁶, —NR⁶R⁷, a phenyl group independently substituted with one or more groups —OH, —OR⁶, —NH₂, —NHR⁶, —NR⁶R⁷, an O-glycosyl group or a N-glycosyl group;
A is hydrogen, ═O, ═S, ═NH,
and at least one agrochemically acceptable vehicle.

4. The agrochemical composition of claim 1 or claim 3 wherein said composition comprises at least one compound selected from the group consisting of cinnamic acid, o-, m- and p-coumaric acids, caffeic acid, ferulic acid, sinapic acid, 5-hydroxicaffeic acid, 5-hydroxiferulic acid, 3,4,5-trimethoxicininamic acid, o-, m- and p-coumaric alcohols, o-, m- and p-coumaric aldehydes, cinnamic alcohol, cinnamic aldehyde, caffeic alcohol, caffeic aldehyde, ferulic alcohol, ferulic aldehyde, coniferyl alcohol, sinapic aldehyde, 5-hydroxiferulic alcohol, 5-hydroxiferulic aldehyde, 5-hydroxicaffeic alcohol, 51-hydroxicaffeic aldehyde, 3,4,5-trimethoxicinnamic alcohol, 3,4,5-trimethoxicinnamic aldehyde, chalcone, naringenin-chalcone, eriodictyol-chalcone, pentahydroxiflavanone-chalcone, the glycosylated derivatives, dimers, trimers, and oligomers of the former compounds, and the like, and at least one agrochemically acceptable vehicle.

5. The agrochemical composition of claim 1 wherein said composition comprises at least one compound of Formnla IV: 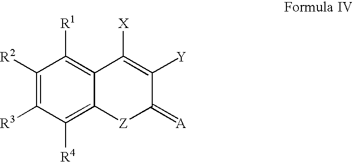
and the salts, esters, ethers, solvates or isomers thereof, or their corresponding O- and/or N-glycosides; wherein R¹ to R⁵ are independently selected from the group consisting of hydrogen, —OH, —OR⁶, —NH₂, —NHR⁶, —NR⁶R⁷, an O-glycosyl group or a N-glycosyl group;
R⁶ and R⁷ are independently selected from the group consisting of a C₁-C₃ alkyl, C₂ alkenyl, C₂ alkynyl, O-glycosyl or N-glycosyl group;
X and Y are independently selected from the group consisting of hydrogen, —OH, —OR⁶, NH₂, —NHR⁶, —NR⁶R⁷, an O-glycosyl group or an N-glycosyl group;
Z is selected from —CH₂—, —CHR⁶—, —CR⁶R⁷—, —O—, —NH—, —NR⁶—, —S—;
A is hydrogen, ═O, ═S, ═NH,
and at least one agrochemically acceptable vehicle.

6. The agrochemical compositions of claim 1 or claim 5 wherein said composition comprises at least one compound selected from the group consisting of coumarin, umbelliferone, 6,7-dihydroxicoumarin, 7,8-dihydroxicoumarin, 4,5,7-trihydroxicoumarin, 7-methoxicoumarin (O-methylumbelliferone), 6,7-dimethoxicoumarin, the glycosylated derivatives, dimers, trimers, and oligomers thereof, and the like, and at least one agrochemically acceptable vehicle.

7. The agrochemical composition of claim 1 wherein said composition comprises at least one compound of Formula V: 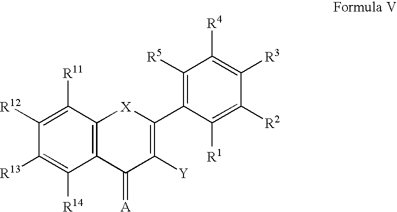
and the salts, esters, ethers, solvates or isomers thereof, or their corresponding O- and/or N-glycosides; wherein R¹ to R⁵ are independently selected from the group consisting of hydrogen, —OH, —OR⁶, —NH₂, —NHR⁶, —NR⁶R⁷, an O-glycosyl group or a N-glycosyl group;
R⁶ and R⁷ are independently selected from the group consisting of a C₁-C₃ alkyl, C₂ alkenyl, C₂ alkynyl, O-glycosyl or N-glycosyl group;
R¹¹ to R¹⁴ are independently selected from the group consisting of hydrogen, —OH, —OR⁶, —NH₂, —NHR⁶, —NR⁶R⁷, an O-glycosyl group or an N-glycosyl group;
X is selected from —CH₂—, —CHR⁶—, —CR⁶R⁷—, —O—, —NH—, —NR⁶—, —S—;
Y is selected from the group consisting of hydrogen, —OH, —OR⁶, —NH₂, —NHR⁶, —NR⁶R⁷, an O-glycosyl group or an N-glycosyl group;
A is hydrogen, ═O, ═S, ═NH,
and at least one agrochemically acceptable vehicle.

8. The agrochemical compositions of claim 1 or claim 7 wherein said composition comprises at least one compound selected from the group consisting of narinigenin, afzelechin, apigeninidini, apiforol, dihydrokaempferol, leucopelargonidin, kaempferol, quercetin, acacetin, apigenini, dihydroquercetin, leucocyanidin, catechin, miricetin, luteolin, eriodictyol, leucopaeonidiin, 3′-O-methyl-luteolin, luteoforol, luteolinidin, gallocatechin, leucodelphinidin, leucopetunidin, leucomalvidin, tricetin, pentahydroxiflavanone, the glycosylated derivatives, dimers, trimers, and oligomers thereof, and the like

9. The agrochemical composition of claim 1 wherein said composition comprises caffeic acid, ferulic acid, p-coumaric acid or a mixture of the same and at least one agrochemically acceptable vehicle.

10. The agrochemical composition of claim 1 wherein said composition comprises from 0.01% to 50% by weight, especially from 1% to 15% by weight, preferably from 2% to 10% by weight, and more preferably from 2% to 5% by weight of the compound of Formula I, based on the weight of the final agrochemical composition.

11. The agrochemical composition of claim 1 wherein said composition comprises from 0.001-5 M, especially from 5-100 mM, preferably from 10-80 mM, and more preferably from 10-50 mM of the compound of Formula I.

12. The agrochemical composition of claim 1 wherein said composition further comprises an additional agrochemical compound.

13. The agrochemical composition according to claim 12 wherein said additional agrochemical compound is selected from the group consisting of a pyrethroid-based pesticide such as allethrin, tetramethrin, resmethrin, phenothrin, furamethrin, permethrin, cypermethrin, deltamethrin, cyhalothrin, cyfluthrin, fenpropathrin, tralomethrin, cycloprothrin, flucythrinate, fluvalinate, acrinathrin, tefluthrin, bifenthrin, empenthrin, betA-cyfluthrin, fenvalerate, esfenvalerate, flubrocythrinate, metofluthrin, profluthrin, dimefluthrin, silafluofen, pyrethrum extract, etofenprox, halfenprox and the like; an organophosphate-based pesticide such as DDVP, cyanophos, fenthion, fenitrothion, tetrachlorvinphos, dimethylvinphos, propaphos, methyl parathion, temephos, phoxim, acephate, isofenphos, salithion, DEP, EPN, ethion, mecarbam, pyridafenthion, diazinon, pirimiphos-methyl, etrimfos, isoxathion, quinalphos, chlorpyrifos methyl, chlorpyrifos, phosalone, phosmet, methidathion, oxydeprofos, vamidothion, malathion, phenthoate, dimethoate, formothion, thiometon, ethylthiometon, phorate, terbufos, profenofos, prothiofos, sulprofos, pyraclofos, monocrotophos, naled, fosthiazate, trichlorfon, ethoprophos, cadusafos, chlorfenvinphos, dichlofenthion, ethylthiometon, methamidophos, dichlorvos, tebupirimfos, omethoate, triazophos, oxydemeton-methyl, azinphos-methyl, chlorethoxyphos, dicrotophos, disulfoton, fenamiphos, phosphamidon, chlormephos, demeton-S-methyl, mevinphos, parathion and the like; a carbamate-based pesticide such as NAC, MTMC, MIPC, BPMC, XMC, PHC, MPMC, ethiofencarb, bendiocarb, pirimicarb, carbosulfan, benfuracarb, methomyl, oxamyl, aldicarb, thiodicarb, alanycarb, carbofuran, methiocarb, fenothiocarb, formetanate, xylylmethylcarbamate, propoxur, isoprocarb and the like; a neonicotinoid-based pesticide such as imidacloprid, nitenpyram, acetamiprid, dinotefuran, thiamethoxam, thiacloprid, clothianidin and the like; an organochlorine-based pesticide such as bromopropylate, dicofol, endosulfan, lindane and the like; an insect growth regulator such as diflubenzuron, chlorfluazuron, teflubenzuron, triflumuron, flufenoxuron, flucycloxuron, hexaflumuron, fluazuron, diafenthiuron, novaluron, noviflumuron, bistrifluoron, chromafenozide, halofenozide, methoxyfenozide, lufenuron, cyromazine, triazamate and the like; a natural product-based pesticide such as nicotine sulphate, polynactin complex, abamectin, milbemectin, lepimectin, BT (Bacillus thuringiensis) agent, spinosad, rotenone and the like; cartap, thiocyclam, bensultap, pymetrozine, fipronil, buprofezin, fenoxycarb, pyriproxyfen, methoprene, hydroprene, kinoprene, endosulfan, triazuron, tebufenozide, benzoepin, emamectin, emamectin benzoate, flupyrazophos, fluacrypyrim, flufenzin, indoxacarb, tolfenpyrad, gammA-cyhalothrin, ethiprole, acetoprole, amidoflumet, chlorfenapyr, flonicamid, flufenerim, pyridalyl, sodium oleate, potassium oleate, azadirachtin, carbam, sodium carbam, propargite, azocyclotin, benzoximate, metaldehyde, protrifenbute, benclothiaz, flubendiamide, metaflumizole; an acaricide such as chlorobenzilate, fenisobromolate, tetradifon, CPCBS (chlorfenson), BPPS, chinomethionat, amitraz, benzomate, hexythiazox, fenbutatin oxide, cyhexatin, dienochlor, clofentezine, pyridaben, fenpyroximate, fenazaquin, tebufenpyrad, pyrimidifen, acequinocyl, bifenazate, etoxazol, spirodiclofen, spiromesifen, amidoflumet and diflovidazin; an azole-based fungicide such as triadimefon, hexaconazole, propiconazole, ipconazole, prochloraz, triflumizole, tebuconazole, epoxiconazole, difenoconazole, flusilazole, triadimenol, cyproconazole, metconazole, fluquinconazole, bitertanol, tetraconazole, triticonazole, flutriafol, penconazole, diniconazole, fenbuconazole, bromuconazole, imibenconazole, simeconazole, myclobutanil, hymexazole, imazalil, furametpyr, thifluzamide, etridiazole, oxpoconazole, oxpoconazole fumarate, pefurazoate, prothioconazole and the like; a pyrimidine-based fungicide such as pyrifenox, fenarimol, nuarimol, bupirimate and the like; an anilinopyrimidine-based fungicide such as mepanipyrim, cyprodinil, pyrimethanil, diflumetorim and the like; an acylalanine-based fungicide such as metalaxyl, metalaxyl-M, oxadixyl, benalaxyl and the like; a benzimidazole-based fungicide such as thiophanate-methyl, benomyl, carbendazim, fuberidazole, thiabendazole and the like; an organosulfur fungicide such as mancozeb, propineb, zineb, metiram, maneb, ziram, thiuram, amobam, polycarbamate, thiadiazine and the like; an organochlorine fungicide such as tetrachloroisophthalonitrile and the like; a carboxam-based fungicide such as ethaboxam, oxycarboxin, carboxin, flutolanil, silthiofam, mepronil, boscalid and the like; a morpholine-based fungicide such as dimethomorph, fenpropidin, fenpropimorph, spiroxamine, tridemorph, dodemorph, flumorph and the like; a strobilurin-based fungicide such as azoxystrobin, kresoxim-methyl, metominostrobin, oryzastrobin, fluoxastrobin, trifloxystrobin, dimoxystrobin, pyraclostrobin, picoxystrobin and the like; a dicarboximide-based fungicide such as iprodione, procymidone, vinclozolin, chlozolinate and the like; a soil fungicide such as flusulfamide, dazomet, methyl isothiocyanate, chloropicrin, methasulfocarb, hydroxyisoxazole, potassium hydroxyisoxazole, echlomezol, dichloropropene, carbam, methyl iodide and the like; a copper-based fungicide such as basic copper chloride, basic copper sulfate, copper nonylphenolsulfonate, oxine copper, DBEDC, anhydrous copper sulfate, copper sulfate pentahydrate, copper hydroxide and the like; an inorganic fungicide such as inorganic sulfur, wettable sulfur powder, lime sulfur, zinc sulfate, fentin, sodium hydrogen carbonate, potassium hydrogen carbonate, hypochlorite salts, metallic silver and the like; an organophosphate-based fungicide such as edifenphos, tolclofos-methyl, fosetyl, iprobenfos, dinocap, pyrazophos and the like; a melanin biosynthesis inhibitor-based fungicide such as carpropamid, fthalide, tricyclazole, pyroquilon, diclocymet, fenoxanil and the like; an antibiotic fungicide such as kasugamycin, validamycin, polyoxin derivative, blasticidin S, tecloftalam, oxytetracycline, mildiomycin, streptomycin and the like; a natural product-based fungicide such as rape seed oil, machine oil and the like; a carbamate-based fungicide such as benthiavalicarB-isopropyl, iprovalicarb, propamocarb, diethofencarb and the like; a pyrrole-based fungicide such as fluoroimide, fludioxonil, fenpiclonil and the like; a plant activator for leading resistance to plant diseases such as probenazole, acibenzolar-5-methyl, tiadinil and the like; a quinoline-based fungicide such as quinoxyfen, oxolinic acid and the like; cyflufenamid, fenhexamid, metrafenone, picobenzamid, proquinazid, famoxadone, cyazofamid, fenamidone, zoxamide, chlorothalonil, cymoxanil, captan, dithianon, fluazinam, folpet, dichlofluanid, triforine, isoprothiolane, ferimzone, diclomezine, pencycuron, chinomethionat, iminoctadine acetate, iminoctadine albesilate, guazatine, chloroneb, organonickel, dodine, quintozene, tolylfluanid, anilazine, nitrothal-isopropyl, fenitropan, dicloran, DPC, dimethirimol, benthiazole, flumetover, mandipropamid and other pesticides and fungicides with similar action used in agricultural, horticultural, fruticultural or floricultural applications.

14. The agrochemical composition of claim 1 wherein said composition further comprises at least one compound selected from the group consisting of wetting, solvent, humectant, dispersing, emulsifier, thickening and chelating agents, buffers, salts, sunscreens, waxes, penetration agents, adherent agents, clays and other components of agrochemical composition is known in the art.

15. A procedure to prepare an agrochemical composition according to claim 1 wherein said procedure comprises mixing a compound of Formula I and at least one agrochemically acceptable vehicle.

16. A method to protect a plant, plant parts, flowers and/or fruits against the harmful effect of ultraviolet radiation wherein said method comprises applying to said plant, plant parts, flowers and/or fruits a composition according to claim 1.

17. A method to decrease the incidence of sunburn in plants, plant parts, flowers and/or fruits against the harmful effect of ultraviolet radiation wherein said method comprises applying to said plants, plant parts, flowers and/or fruits a composition according to claim 1.

18. A method to alter the color of plants, plant parts, flowers and/or fruits against the harmful effect of ultraviolet radiation wherein said method comprises applying to said plant, plant parts, flowers and/or fruits a composition according to claim 1.

19. The method of claim 18 wherein said alteration of the color of said plants, plant parts, flowers and/or fruits is a color turn of said plants, plant parts, flowers and/or fruits to red, blue, purple, violet, orange and/or yellow tonalities, departing from green color.

20. A method to alter the synthesis of polyphenolic compounds in plants wherein said method comprises applying to said plant a composition according to claim 1.

21. The method of claim 20 wherein said alteration of the synthesis of polyphenolic compounds in plants is an increase of the synthesis of polyphenolic compounds in plants.

22. A method to alter the synthesis of flavonoids in plants wherein said method comprises applying to said plant a composition according to claim 1.

23. The method of claim 22 wherein said alteration of the synthesis of flavonoids in plants is an increase of the synthesis of flavonoids in plants.

24. A method to improve the nutritional value of plants, plant parts, flowers and/or fruits wherein said method comprises applying to said plant, plant parts, flowers and/or fruits a composition according to claim 1.

25. The method according to any of the claims 16, 17, 18, 20, 22 or 24 wherein said composition is directly sprayed over said plants, plant parts, flowers and/or fruits.

26. A plant, plant part, flower, fruit and/or propagation material wherein said plant, plant part, flower, fruit and/or propagation material is treated with a composition according to claim 1.
